(19) United States
(12) Patent Application Publication
(10) Pub. No.: US 2017/0332677 A1
(43) Pub. Date: Nov. 23, 2017

(54) CO-EXTRUDED SNACK PRODUCT

(71) Applicant: INTERCONTINENTAL GREAT BRANDS LLC, East Hanover, NJ (US)

(72) Inventors: Ana Patricia RODRIGUEZ, East Hanover, NJ (US); Julie SMITH, East Hanover, NJ (US); Alan KINO, East Hanover, NJ (US); Francois P. ERRANDONEA, East Hanover, NJ (US); Gay KASEGRANDE, East Hanover, NJ (US); Nimesh K. PATEL, East Hanover, NJ (US); Minerva Jimenez ESPINOSA, East Hanover, NJ (US)

(73) Assignee: Intercontinental Great Brands LLC, East Hanover, NJ (US)

(21) Appl. No.: 15/525,454

(22) PCT Filed: Nov. 9, 2015
(86) PCT No.: PCT/US2015/059724

§ 371 Date: May 9, 2017

Related U.S. Application Data
(60) Provisional application No. 62/077,554, filed on Nov. 10, 2014.

(51) Int. Cl. A23L 7/122; A23P 30/25; A23L 7/13; A23P 20/25

(52) U.S. Cl. CPC A23L 7/122; A23P 20/25; A23P 30/25; A23L 7/13

(57) ABSTRACT

A crispy co-extruded snack product includes an extruded casing having a flour component that includes from about 37% to about 92% by weight wheat flour; and an extruded filling disposed within the extruded casing wherein filling weight is from about 20 wt % to about 75 wt % of total weight of the co-extruded foodstuff.

### CROSS-REFERENCE TO RELATED APPLICATION

This application claims the benefit of U.S. Provisional Patent Application Ser. No. 62/077,554, entitled “Co-Extruded Snack Product,” filed on Nov. 10, 2014, the entire content of which is incorporated herein by reference.

### BACKGROUND OF THE INVENTION

Many extruded food products have a texture that is hard and crunchy. It is desirable to produce extruded products that have a crispy texture. The present invention generally relates to extruded food products, such as co-extruded filled products, having a crispy texture.

### BRIEF SUMMARY OF THE INVENTION

In some embodiments the invention provides a crispy co-extruded foodstuff comprising an extruded casing having a flour component that includes from about 37% to about 92% by weight wheat flour; and an extruded filling disposed within the extruded casing wherein filling weight is from about 20 wt % to about 75 wt % of total weight of the co-extruded foodstuff. In some embodiments the invention provides a crispy co-extruded foodstuff comprising an extruded casing having a flour component that includes from about 37% to about 92% by weight wheat flour and from about 3% to about 30% by weight sugar; an extruded filling disposed within the extruded casing wherein filling weight is from about 20 wt % to about 75 wt % of total weight of the co-extruded foodstuff; and wherein the overall co-extruded foodstuff has a density of about 0.45 g/mL to about 0.85 g/mL. In some embodiments the extruded casing includes about 10 wt % to about 20 wt % of sugar.

In some embodiments a crispy co-extruded foodstuff further includes a flour component that consists essentially of wheat flour. In other embodiments, a crispy co-extruded foodstuff includes a casing that further includes up to about 20 wt % of a non-wheat flour, wherein the non-wheat flour includes at least one of rice flour, corn flour, and potato flour.

In some embodiments, a crispy co-extruded foodstuff according to any embodiment described herein has a density of about 0.6 g/mL to about 0.8 g/mL. In some embodiments, a crispy co-extruded foodstuff according to any embodiment described herein has an Aw of about 0.1 to about 0.6. In some embodiments, a crispy co-extruded foodstuff according to any embodiment described herein has a moisture content of about 0.5 wt % to about 4 wt % of the weight of the co-extruded foodstuff. In some embodiments, a crispy co-extruded foodstuff according to any embodiment described herein comprises a filling that has a viscosity of from about 2500 cP to about 25000 cP. In some embodiments, a crispy co-extruded foodstuff according to any embodiment described herein has a length dimension that is greater than a width dimension and has a compressive strength along the width dimension of from about 150 g to about 1200 g. In some embodiments, a crispy co-extruded foodstuff according to any embodiment described herein has a length dimension that is greater than a width dimension and has a compressive strength along the length dimension of from about 220 g to about 1300 g.

In some embodiments a crispy co-extruded foodstuff according to any embodiment described herein includes a casing that comprises from about 5% to about 15% by weight cocoa, from about 5% to about 30% by weight cocoa, from about 9% to about 18% by weight cocoa, or from about 10% to about 15% by weight cocoa.

In some embodiments the invention provides a method of co-extruding a baked foodstuff comprising mixing a casing material comprising from about 10% to about 100% by weight wheat flour and from about 10% to about 20% by weight sugar; mixing a filling material comprising a solid fat, a liquid fat, and sugar; and co-extruding the casing material and filling material at filling to casing ratio of about 1:4 to about 3:1 to produce a co-extruded rope.

### BRIEF DESCRIPTION OF THE SEVERAL VIEWS OF THE DRAWINGS

The foregoing summary, as well as the following detailed description of certain embodiments of the food product will be better understood when read in conjunction with the following exemplary embodiments, the appended drawings, and the appendices.

FIG. 1 is a side cut-away view of an idealized embodiment of the invention;

FIG. 2 is a top-view of representative samples of an embodiment of the invention;

FIG. 3 is a top view of a representative sample of an embodiment of the invention;

FIG. 4 is a side-view of a representative sample of an embodiment of the invention;

FIG. 5 is a side cut-away view of a representative sample of an embodiment of the invention;

FIG. 6 is a top view of a representative sample of an embodiment of the invention;

FIG. 7 is a side-view of a representative sample of an embodiment of the invention;

FIG. 8 is a side cut-away view of a representative sample of an embodiment of the invention;

FIG. 9 is a top-view of representative samples of an embodiment of the invention;

FIG. 10 is a process flow diagram of an embodiment of the invention;

FIG. 11 is a top-view of an exemplary crimper mold that can be used in embodiments of the invention;

FIG. 12 is a top view of a representative sample of an embodiment of the invention;

FIG. 13 is a top view of a representative sample of an embodiment of the invention;

FIG. 14 is a top view of a representative sample of an embodiment of the invention;

FIG. 15 is a side-view of a representative sample of an embodiment of the invention;

FIG. 16 is a top view of a representative sample of an embodiment of the invention;

FIG. 17 is a side-view of a representative sample of an embodiment of the invention;

FIG. 18 is a side-view of a representative sample of an embodiment of the invention;

FIG. 19 is a side cut-away view of a representative sample of an embodiment of the invention;

FIG. 20 is a side cut-away view of a representative sample of an embodiment of the invention;

FIG. 21 is a top view of a representative sample of an embodiment of the invention;

FIG. 22 is a top view of a representative sample of an embodiment of the invention;

FIG. 23 is a top view of a representative sample of an embodiment of the invention;

FIG. 24 is a side-view of a representative sample of an embodiment of the invention;

FIG. 25 is a side-view of a representative sample of an embodiment of the invention;

FIG. 26 is a side-view of a representative sample of an embodiment of the invention;

FIG. 27 is a side-view of a representative sample of an embodiment of the invention;

FIG. 28 is a side cut-away view of a representative sample of an embodiment of the invention;

FIG. 29 is a side cut-away view of a representative sample of an embodiment of the invention;

FIG. 30 is a perspective view of a representative sample of an embodiment of the invention;

FIG. 31 is a top view of a representative sample of an embodiment of the invention;

FIG. 32 is a top view of a representative sample of an embodiment of the invention;

FIG. 33 is a side-view of a representative sample of an embodiment of the invention;

FIG. 34 is a perspective view of a representative sample of an embodiment of the invention;

FIG. 35 is a side-view of a representative sample of an embodiment of the invention;

FIG. 36 is a side-view of a representative sample of an embodiment of the invention;

FIG. 37 is a side cut-away view of a representative sample of an embodiment of the invention;

FIG. 38 is a perspective cut-away view of a representative sample of an embodiment of the invention;

FIG. 39 is a perspective view of a representative sample of an embodiment of the invention;

FIG. 40 is a top view of a representative sample of an embodiment of the invention;

FIG. 41 is a top view of a representative sample of an embodiment of the invention;

FIG. 42 is a side-view of a representative sample of an embodiment of the invention;

FIG. 43 is a top view of a representative sample of an embodiment of the invention;

FIG. 44 is a side-view of a representative sample of an embodiment of the invention;

FIG. 45 is a side-view of a representative sample of an embodiment of the invention;

FIG. 46 is a side cut-away view of a representative sample of an embodiment of the invention;

FIG. 47 is a perspective cut-away view of a representative sample of an embodiment of the invention;

FIG. 48 is a perspective view of a representative sample of an embodiment of the invention;

FIG. 49 is a top view of a representative sample of an embodiment of the invention;

FIG. 50 is a top view of a representative sample of an embodiment of the invention;

FIG. 51 is a side-view of a representative sample of an embodiment of the invention;

FIG. 52 is a side-view of a representative sample of an embodiment of the invention;

FIG. 53 is a side-view of a representative sample of an embodiment of the invention;

FIG. 54 is a side-view of a representative sample of an embodiment of the invention;

FIG. 55 is a side cut-away view of a representative sample of an embodiment of the invention;

FIG. 56 is a perspective cut-away view of a representative sample of an embodiment of the invention;

FIG. 57 is a perspective view of a representative sample of an embodiment of the invention;

FIG. 58 is a top view of a representative sample of an embodiment of the invention;

FIG. 59 is a top view of a representative sample of an embodiment of the invention;

FIG. 60 is a side-view of a representative sample of an embodiment of the invention;

FIG. 61 is a side-view of a representative sample of an embodiment of the invention;

FIG. 62 is a side-view of a representative sample of an embodiment of the invention;

FIG. 63 is a side-view of a representative sample of an embodiment of the invention;

FIG. 64 is a side-view of a representative sample of an embodiment of the invention; and

FIG. 65 is a side cut-away view of a representative sample of an embodiment of the invention.

### DETAILED DESCRIPTION OF THE INVENTION

Compositions and methods of the present invention relate to a co-extruded snack product (also referred to herein as a co-extruded foodstuff) having a casing and a filling, wherein the filling is disposed within the casing.

A casing of a co-extruded snack product according to the invention may have a texture and taste that is crispy. In some embodiments extruded snack products of the invention have a dual texture such as a light, crispy shell and a soft, creamy center. In some embodiments a co-extruded snack product may have a high degree of munchability—that is, a light crispy texture and requiring little effort for the consumer to chew the product. In some embodiments a co-extruded snack product of the invention has gentle, well-balanced flavors. In some embodiments the extruded snack product has a texture that is generally not messy, for example, the extruded snack product may leave few or essentially no crumbs when eaten. In some embodiments extruded snack products of the invention have a smooth appearance.

In some embodiments, a co-extruded snack product has a plump look. In some embodiments a co-extruded snack product has a high percentage of filling. In some embodiments a co-extruded snack product has a dimension sufficiently small that a consumer could easily eat the extruded snack product in a single bite.

In some embodiments extruded snack products of the invention have contrasting colors on the exterior surface. Such contrasting colors may be achieved by, for example, particulates disposed on the exterior surface. In some embodiments one or more of the colors on the surface may signal to the consumer the extruded filling on the center of the product. For example, in some embodiments of a co-extruded snack product having a chocolate casing and a white filling, the exterior surface of the dark casing may have white particulates disposed on it.

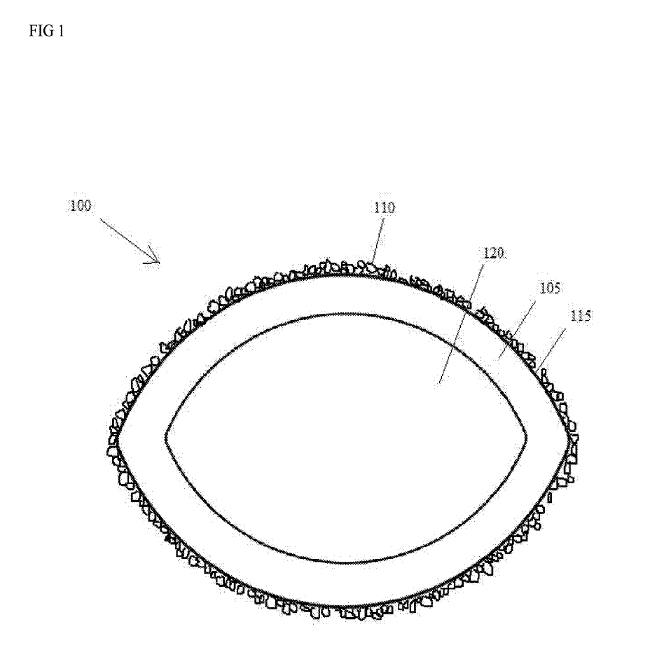

Referring to FIG. 1, in some embodiments a co-extruded snack product can be a coated co-extruded snack product 100. Coated co-extruded snack product 100 of the invention may include a casing component 105 having an external surface 115. In some embodiments the casing component can include a cocoa. Coated co-extruded snack product 100 may also have a particulate component 110 that may at least partially cover the external surface 115 of the casing component 105. In some embodiments the particulate component 110 can include cocoa, agglomerated particles, or a combination of cocoa and agglomerated particles. The coated extruded snack product 100 may further include a filling 120 disposed within the casing component 105, such as a crème filling.

The ornamental features of an embodiment are shown in the attached Appendix, which forms a portion of the present Specification.

In some embodiments, the coated co-extruded snack product 100 may generally be prepared by co-extruding a casing portion together with a filling 120 through a co-extrusion die to form a ribbon or rope, shaping the ribbon or rope into individual pieces and applying a binder or coating to an external surface of the individual pieces. Some embodiments further include at least partially coating the individual pieces with a particulate component. In some embodiments, the extruded foodstuff can weigh in the range of from about 0.2 g to about 4 g, from about 0.25 to about 2 g; from about 0.3 g to about 3.75 g, from about 0.4 g to about 3.5 g, from about 0.5 g to about 3.25 g, from about 0.6 g to about 3 g, from about 0.4 g to about 2.75 g, from about 0.5 g to about 2.5 g, from about 0.6 g to about 2.25 g, from about 0.7 g to about 2 g, from about 0.8 g to about 1.75 g or from about 1 g to about 1.5 g. In some embodiments, the extruded foodstuff can weigh about 0.25 g, about 0.5 g, about 0.55 g, about 0.6 g, about 0.65 g, about 0.7 g, about 0.75 g, about 0.8 g, about 0.85 g, about 0.9 g, about 0.95 g, about 1 g, about 1.5 g, about 2 g, or about 2.5 g.

In other embodiments, a co-extruded snack product can be an uncoated extruded snack product. An uncoated extruded snack product can include a casing component. An uncoated extruded snack product can further include a filling disposed inside the casing component. In some embodiments an uncoated co-extruded snack product can be made in a manner similar to that of a coated extruded snack product, without the step of coating the casing component with a binder/coating and/or a particulate component.

In some embodiments, a co-extruded snack product weighs from about 0.1 g to about 2.5 g, from about 0.5 to about 2 g, from about 0.7 g to about 1.5 g, from about 1 g to about 1.3 g, from about 0.1 g to about 1.5 g, or from about 0.7 g and about 2.5 g.

In some embodiments, a co-extruded snack product weighs about 0.1 g, about 0.3 g, about 0.5 g, about 0.6 g about 0.7 g, about 0.8 g about 0.9 g, about 1 g, about 1.1 g, about 1.2 g, about 1.3 g about 1.4 g, about 1.5 g, about 1.6 g, about 1.7 g, or about 2 g.

In some embodiments, a co-extruded snack product weighs at least 0.1 g, at least 0.3 g, at least 0.5 g, at least 0.6 g at least 0.7 g, at least 0.8 g, at least 0.9 g, at least 1 g, at least 1.1 g, at least 1.2 g, at least 1.3 g at least 1.4 g, or at least 1.5 g.

In some embodiments, a co-extruded snack product weighs up to 0.7 g, up to 0.8 g, up to 0.9 g, up to 1 g, up to 1.1 g, up to 1.2 g, up to 1.3 g, up to 1.4 g, up to 1.5 g, up to 1.6 g, up to 1.7 g, up to 2 g, or up to 2.5 g.

A co-extruded snack product can be characterized by its density (also referred to herein as specific volume). As used herein, an overall density measurement of a co-extruded snack product (i.e. a co-extruded snack product including a casing and a filling, and optionally a coating) is made by dividing the sample volume (cm³ or in³) by the sample weight (g or oz). Specific volume is expressed in cubic centimeters per gram (cm³/g) or cubic inches per ounce (in³/oz). Density or specific volume may be measured in accordance with AACC 10-05.01, which is hereby incorporated by reference in its entirety. In particular, the volume of the extruded snack product can be measured by using a calibrated volumeter to measure the volume of a quantity of rapeseeds, and then measuring the volume of the same quantity of rapeseeds together with the extruded snack product; the difference is the displaced volume, which is equal to the volume of the extruded snack product.

The density measurement of an extruded casing can be indicative of the texture of a co-extruded snack product. For example, a lower density of an empty casing can indicate the extruded snack product has a texture that is crispier, with a lighter, more delicate texture, compared to an empty casing that has a higher density and is crunchier. The density of a casing without filling can be measured by measuring the displaced volume of rapeseeds, as described above and in AACC 10-05.01. The overall density of a co-extruded snack product may be indicative of the texture of the casing if the percentage of filling and the type of filling are taken into account.

In some embodiments, a co-extruded snack product has a density from about 0.4 g/mL to about 0.7 g/mL, from about 0.45 g/mL to about 0. 65 g/mL, from about 0.45 g/mL to about 0.85 g/mL, from about 0.5 g/mL to about 0.6 g/mL, from about 0.35 g/mL to about 0.75 g/mL, from about 0.3 g/mL to about 0.8 g/mL, from about 0.25 g/mL to about 0.85 g/mL, from about 0.1 g/mL to about 1 g/mL, from about 0.25 g/mL to about 0.65 g/mL, from about 0.6 g/mL to about 0.8 g/mL, from about 0.5 g/mL to about 0.9 g/mL, or from about 0.45 g/mL to about 0.85 g/mL.

In some embodiments, a co-extruded snack product has a density of about 0.4 g/mL about 0.45 g/mL, about 0.5 g/mL, about 0.55 g/mL, about 0.6 g/mL, about 0.65 g/mL, about 0.7 g/mL, about 0.75 g/mL, about 0.8 g/mL, about 0.85 g/mL, or about 0.9 g/mL.

In some embodiments, a co-extruded snack product has a density of at least 0.35 g/mL, at least 0.4 g/mL, at least 0.45 g/mL, at least 0.5 g/mL, at least 0.55 g/mL, at least 0.6 g/mL, at least 0.65 g/mL, at least 0.7 g/mL, or at least 0.75 g/mL.

A co-extruded snack product can be characterized by its water activity (A_{w}), a measure of the ratio between the vapor pressure of the extruded snack product itself, when in a completely undisturbed balance with the surrounding air media, and the vapor pressure of distilled water under identical conditions. The A_{w} of a co-extruded snack product can be indicative of the texture of that product. In general, a product with a higher A_{w} the product will be less crispy.

In some embodiments, a co-extruded snack product has an A_{w} of from about 0.1 to about 1, from about 0.1 to about 0.85, from about 0.1 to about 0.85, from about 0.2 to about 0.7, from 0.25 to about 0. 65, from about 0.3 to about 0.6, from about 0.35 to about 0.55, from about 0.4 to about 0.5, from about 0.3 to about 0.5, from about 0.4 to about 0.6, from about 0.2 to about 0.6, or from about 0.3 to about 0.7.

In some embodiments, a co-extruded snack product has an A_{w} of about 0.2, about 0.25, about 0.3, about 0.35, about 0.4, about 0.45, about 0.5, about 0.55, about 0.6, about 0.65, about 0.7, or about 0.75.

In some embodiments, a co-extruded snack product has an A_{w} of at least 0.2, at least 0.25, at least 0.3, at least 0.35, at least 0.4, at least 0.45, at least 0.5, at least 0.55, or at least 0.6.

In some embodiments, a co-extruded snack product has an A_{w} of up to 0.3, up to 0.35, up to 0.4, up to 0.45, up to 0.5, up to 0.55, up to 0.6, up to 0.65, up to 0.7, or up to 0.75.

A co-extruded snack product can be characterized by its moisture content. As used herein, an moisture content measurement of a co-extruded snack product is made

In some embodiments, a co-extruded snack product has a moisture content of from about 0.1 wt % to about 5%, from about 0.5 wt % to about 4 wt %, from about 1 wt % to about 3 wt %, from 0.1 wt % to about 3%, or from about 1 wt % to about 3.5 wt %.

In some embodiments, a co-extruded snack product has a moisture content of about 0.1 wt %, about 0.5 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3 wt %, about 3.5 wt %, about 4 wt %, about 4.5 wt %, or about 5 wt %.

In some embodiments, a co-extruded snack product has a moisture content of at least 0.1 wt %, at least 0.5 wt %, at least 1 wt %, at least 1.1 wt %, at least 1.2 wt %, at least 1.3 wt %, at least 1.4 wt %, at least 1.5 wt %, at least 1.6 wt %, at least 1.7 wt %, at least 1.8 wt %, at least 1.9 wt %, at least 2 wt %, at least 2.1 wt %, at least 2.2 wt %, at least 2.3 wt %, at least 2.4 wt %, at least 2.5 wt %, at least 2.6 wt %, at least 2.7 wt %, at least 2.8 wt %, at least 2.9 wt %, or at least 3 wt %.

In some embodiments, a co-extruded snack product has a moisture content of up to 1 wt %, up to 1.1 wt %, up to 1.2 wt %, up to 1.3 wt %, up to 1.4 wt %, up to 1.5 wt %, up to 1.6 wt %, up to 1.7 wt %, up to 1.8 wt %, up to 1.9 wt %, up to 2 wt %, up to 2.1 wt %, up to 2.2 wt %, up to 2.3 wt %, up to 2.4 wt %, up to 2.5 wt %, up to 2.6 wt %, up to 2.7 wt %, up to 2.8 wt %, up to 2.9 wt %, up to 3 wt %, up to 3.5 wt %, or up to 4 wt %.

A co-extruded snack product can be characterized by its hardness, a measure of the force necessary to crush the extruded snack product. As used herein, a hardness measurement of a co-extruded snack product is made by shearing/crushing individual pieces using a texture analyzer with a 3 mm thick flat bottom blade and slotted base. During the test, the blade proceeds through the sample, shearing/crushing both the top and bottom shell/crust. The maximum force generated during the test represents sample hardness. As used herein, multiple pieces were tested for each variable (typically 30 pieces are tested). The hardness parameters provided herein refer to an average of the maximum force for the replicates for the ample/variable. The hardness parameters provided herein were measured using a TAXT2 or TAXT Plus instrument with a 25 kg or 50 kg load cell preferred (50 kg load cell limit was exceeded for some samples) and equipped with a flat bottom blade (69.8 mm wide, 3 mm thick) with guillotine supports and slotted base. The hardness parameters provided herein were measured using the test settings set forth in Table 1.

TABLE 1

| Test type | Return to start. Measure force in compression | |
|---|---|---|
| Pre- test speed | 1.0 | mm/sec |
| Test speed | 2.0 | mm/sec |
| Post test speed | 10.0 | mm/sec |
| Test distance | 15 | mm |
| Trigger type | Auto | |
| Trigger Force | 20 | g |
| Data rate | 250 | pps |

For each measurement, a single piece is placed on the base, centered under the blade. Each piece has a length (long axis) and a width (short axis). The piece is oriented so that the blade passes through the crimped edges on the sides of the sample. Samples can also be tested across the short axis—parallel to rather than through the crimp to assess effect of piece dimensions on the force measured.

In some embodiments, a co-extruded snack product has hardness measured across the length of the sample of from about 100 g to about 1800 g, from about 200 g to about 1400 g, from about 220 to about 1300 g, from about 300 g to about 1300 g, from about 400 g to about 1200 g, from about 500 g to about 1100 g, from about 600 g to about 1000 g, from about 700 to about 900 g, from about 700 g to about 1500 g, from about 600 g to about 1400 g, from about 500 g to about 1300 g, from about 400 g to about 1200 g, from about 300 g to about 100 g, or from about 200 g to about 1000 g.

In some embodiments, a co-extruded snack product has hardness measured across the length of the sample of about 100 g, about 200 g, about 300 g, about 400 g, about 500 g, about 600 g, about 650 g, about 700 g, about 750 g, about 800 g, about 850 g, about 900 g, about 1000 g, about 1100 g, about 1200 g, about 1300 g, about 1400 g, about 1500 g, about 1600 g, about 1700 g, or about 1800 g.

In some embodiments, a co-extruded snack product has hardness measured across the length of the sample of at least 100 g, 200 g, 300 g, 400 g, 500 g, 600 g, 700 g, 800 g, 900 g, 1000 g, 1100 g, 1200 g, 1300 g, 1400 g, or 1500 g.

In some embodiments, a co-extruded snack product has hardness measured across the length of the sample of up to 500 g, 600 g, 700 g, 800 g, 900 g, 1000 g, 1100 g, 1200 g, 1300 g, 1400 g, 1500 g, 1600 g, 1700 g, or about 1800 g.

In some embodiments, a co-extruded snack product has hardness measured across the width of the sample of from about 150 g to about 1200 g, from about 200 g to about 1100 g, from about 300 g to about 1000 g, from about 400 g to about 900 g, from about 500 g to about 800 g, from about 600 g to about 700 g, from about 100 g to about 400 g, from about 200 g to about 500 g, from about 300 to about 600 g, from about 300 g to about 700 g, from about 400 to about 800 g, from about 500 to about 900 g, from about 600 to about 1000 g, from about 700 g to about 1100 g, from about 800 to about 1200 g, or from about 900 to about 1300 g.

In some embodiments, a co-extruded snack product has hardness measured across the width of the sample of about 100 g, about 200 g, about 300 g, about 400 g, about 500 g, about 550 g, about 600 g, about 650 g, about 700 g, about 750 g, about 800 g, about 900 g, about 1000 g, about 1100 g, or about 1200 g.

In some embodiments, a co-extruded snack product has hardness measured across the width of the sample of at least 100 g, 200 g, 300 g, 400 g, 500 g, 600 g, 700 g, 800 g, 900 g, 1000 g, 1100 g, 1200 g, or 1300 g.

In some embodiments, a co-extruded snack product has hardness measured across the width of the sample of up to 100 g, 200 g, 300 g, 400 g, 500 g, 600 g, 700 g, 800 g, 900 g, 1000 g, 1100 g, 1200 g, or 1300 g.

A co-extruded snack product can be characterized by its cell structure. In general, a co-extruded snack product with more cells per unit will result in a lighter snack product than a co-extruded snack product with fewer cells per unit. In general, a co-extruded snack product with smaller cells in a certain volume will result in a lighter snack product. The number of particles in a cross-section of a co-extruded snack product piece can describe a cell structure, as can the number of air pockets in a cross-section of a co-extruded snack product piece (also referred to herein as the porosity of a co-extruded snack product piece). To determine the cell structure, the extruded snack product is prepared by cutting a cross-section on the short axis of the extruded snack product. The cross section is analyzed using a scanning electron microscope (SEM) generally as described in Ryu et al, Cereal Chem. 70(3):291-297, hereby incorporated by reference in its entirety, and by counting the number of particles (or air pockets) in the cross-section of a piece, or by counting the number of particles (or air pockets) in several cross-sections of a piece and averaging over the number of cross-sections examined. As used herein, average number of particles refers to the average number of particles in a cross-section of extruded snack product.

In some embodiments, a co-extruded snack product has an average number of particles per mm² cross-section of a co-extruded snack product of from about 2 to about 6.5, from about 2 to about 6, from about 2 to about 5, from about 3 to about 5, from about 3.5 to about 5.5, from about 4 to about 5, or from about 4.2 to about 4.8.

In some embodiments, a co-extruded snack product has an average number of particles per mm² cross-section of a co-extruded snack product of about 2, about 2.5, about 3, about 3.5, about 3.6, about 3.7, about 3.8, about 3.9, about 4.0, about 4.1, about 4.2, about 4.3, about 4.4, about 4.5, or about 4.6, about 4.7, about 4.8, about 4.9, about 5, about 5.5, or about 6.

In some embodiments, a co-extruded snack product has an average number of particles per mm² cross-section of a co-extruded snack product of up to 6.5, 6, 5.5, 5, 4.9, 4.8, 4.7, 4.6, or 4.5.

The cell structure can also be analyzed by using SEM to analyze a cross-section of a co-extruded snack product and measuring the size of the particles (and/or air pockets) in the extruded snack product. The SEM image can also be used to determine the average particle size by measuring along the long axis of the particle, or by measuring along the long axis of several particles and averaging the measurement over the number of particles examined.

In some embodiments, a co-extruded snack product has an average particle size of from about 0.3 mm to about 0.7 mm, from about 0.3 mm to about 0.6 mm, from about 0.4 mm to about 0.5 mm, from about 0.3 mm to about 0.5 mm, or from about 0.4 mm to about 0.6 mm.

In some embodiments, a co-extruded snack product has an average particle size of about 0.39 mm, about 0.4 mm about 0.41 mm, about 0.42 mm, about 0.43 mm, about 0.44 mm, about 0.45 mm, about 0.46 mm, about 0.47 mm, about 0.48 mm, about 0.49 mm, about 0.5 mm, or about 0.51 mm.

In some embodiments, a co-extruded snack product has an average particle size of at least about 0.39 mm, about 0.4 mm about 0.41 mm, about 0.42 mm, about 0.43 mm, about 0.44 mm, about 0.45 mm, about 0.46 mm, about 0.47 mm, about 0.48 mm, about 0.49 mm, about 0.5 mm, or about 0.51 mm.

In some embodiments, a co-extruded snack product has a moisture content of from about 0.1 wt % to about 5%, from about 0.5 wt % to about 4 wt %, from about 1 wt % to about 3 wt %, from 0.1 wt % to about 3%, or from about 1 wt % to about 3.5 wt %.

In some embodiments, a co-extruded snack product has a moisture content of about 0.1 wt %, about 0.5 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3 wt %, about 3.5 wt %, about 4 wt %, about 4.5 wt %, or about 5 wt %.

In some embodiments, a co-extruded snack product has a moisture content of at least 0.1 wt %, at least 0.5 wt %, at least 1 wt %, at least 1.1 wt %, at least 1.2 wt %, at least 1.3 wt %, at least 1.4 wt %, at least 1.5 wt %, at least 1.6 wt %, at least 1.7 wt %, at least 1.8 wt %, at least 1.9 wt %, at least 2 wt %, at least 2.1 wt %, at least 2.2 wt %, at least 2.3 wt %, at least 2.4 wt %, at least 2.5 wt %, at least 2.6 wt %, at least 2.7 wt %, at least 2.8 wt %, at least 2.9 wt %, or at least 3 wt %.

In some embodiments, a co-extruded snack product has a moisture content of up to 1 wt %, up to 1.1 wt %, up to 1.2 wt %, up to 1.3 wt %, up to 1.4 wt %, up to 1.5 wt %, up to 1.6 wt %, up to 1.7 wt %, up to 1.8 wt %, up to 1.9 wt %, up to 2 wt %, up to 2.1 wt %, up to 2.2 wt %, up to 2.3 wt %, up to 2.4 wt %, up to 2.5 wt %, up to 2.6 wt %, up to 2.7 wt %, up to 2.8 wt %, up to 2.9 wt %, up to 3 wt %, up to 3.5 wt %, or up to 4 wt %.

Casing Component

Shape

The casing component can have an external surface and have any shape suitable for a snack-sized foodstuff that can be created from an extruded material, for example using a crimper and/or a chain die cutter. Example shapes include shapes that are generally pillow shaped, spheroid, prolate spheroid (e.g. coffee bean), oblate spheroid (e.g. lentil), and cylindrical (e.g. hockey puck).

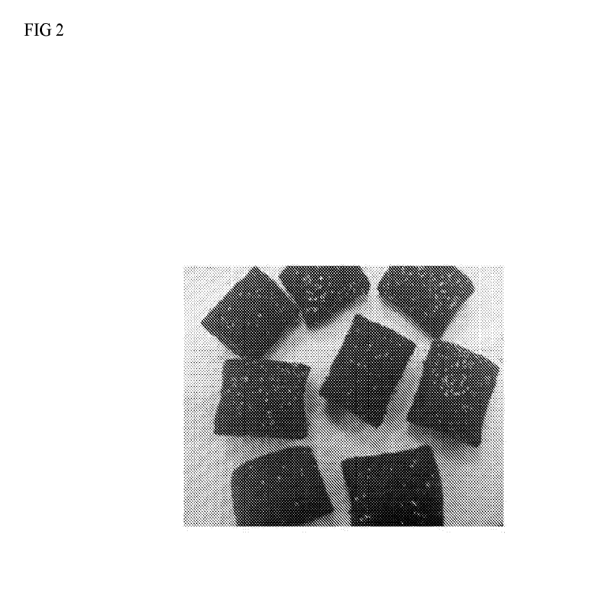

The term “pillow shaped” can be better understood with reference to FIG. 2 and refers to a shape that is generally rectangular when viewed from the top, with sides that may be approximately straight, or may have a slight curvature towards or away from the center of the rectangle, and has the general shape of a vesica piscis when a viewed from the side. It is to be understood that the term pillow shaped includes shapes that are not perfectly symmetrical about any axis.

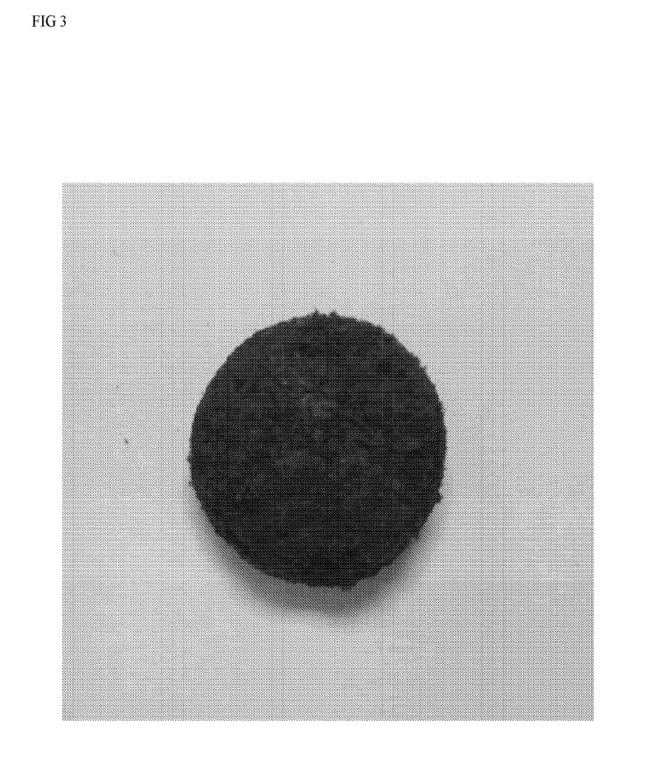

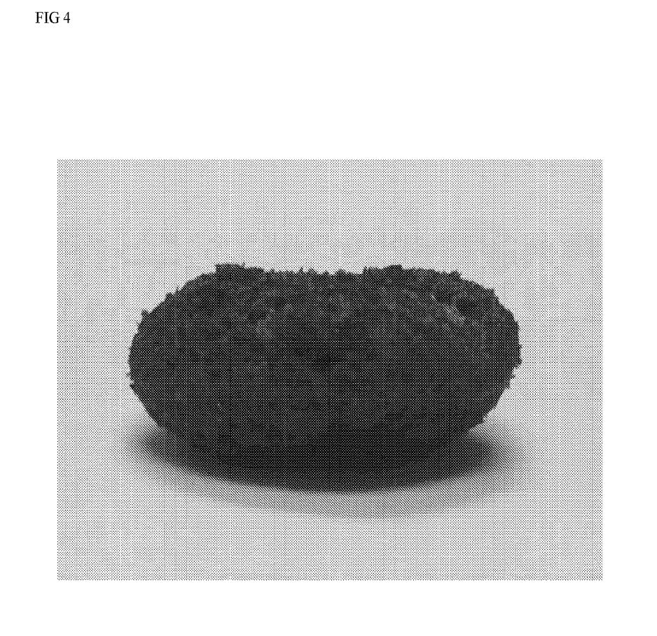

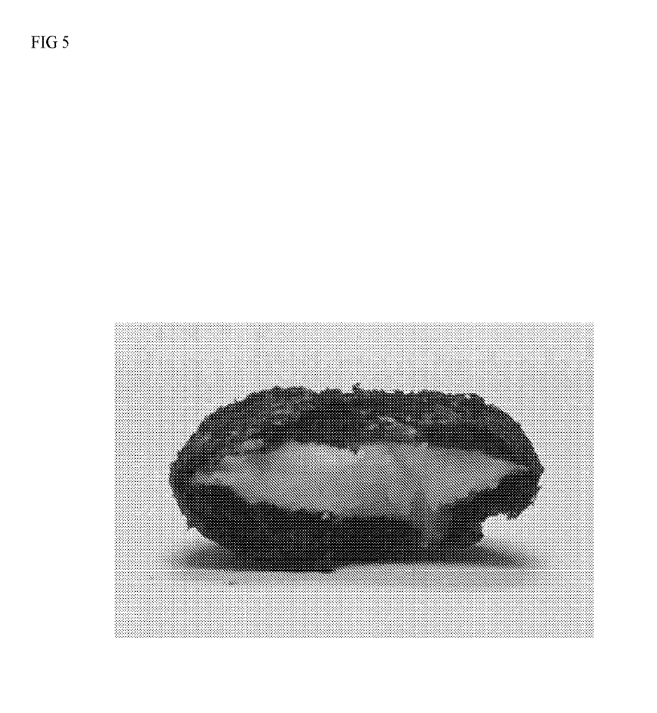

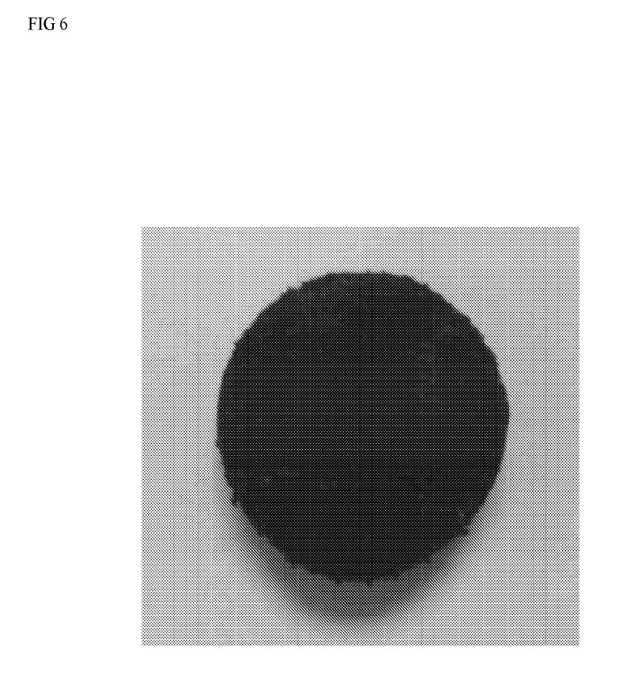

The term “spheroid” can include shapes that approximate a sphere, but have minor variations in the surface and/or are not perfectly symmetrical. The term spheroid can also include sphere-like shapes, such as an oblate spheroid, that resemble a slightly flattened sphere and may be more ovular than circular when viewed from any side, but still retain a generally circular shape when viewed from the top or bottom, similar to that of a lentil. The term oblate spheroid can be better understood with reference to FIGS. 3-8. FIGS. 3 and 6 each show a top view of a co-extruded food product of the invention, with FIG. 3 showing a casing component and FIG. 6 showing a casing component coated with a particulate component. FIGS. 4 and 7 each show a side view of a co-extruded food product of the invention, with FIG. 4 showing a casing component and FIG. 7 showing a casing component coated with a particulate component. FIGS. 5 and 8 each show a cross-section of a co-extruded food product of the invention, with FIG. 5 showing a casing component and a filling disposed inside the casing component and FIG. 8 showing a casing component, a filling disposed inside the casing component, and a particulate component disposed on the external surface of the casing component. The term spheroid can also include sphere-like shapes, such as a prolate spheroid, and can be better understood with reference to FIG. 9. FIG. 9 shows a top view of coated extruded foodstuffs of the invention having a generally prolate spheroid shape. Prolate spheroid can refer to an approximately rotationally symmetric ellipsoid that resembles an oval when viewed from the top, bottom and side, but resembles a circle when viewed from the end, similar to that of a coffee bean. Cylindrical can include cylindrical-like shapes, for example, having slight curvature to the top and/or bottom surface, and/or the edges where the top and/or bottom meet the side.

As shown in FIGS. 3-9, there can be variation in the shape from one extruded foodstuff (coated or uncoated) to the next, and each extruded foodstuff may display variations in the topography that render the extruded foodstuff asymmetrical or somewhat irregularly shaped. For example, there may be variation in the thickness, width, or depth of a single casing component.

Flour

In some embodiments, a casing component of a co-extruded foodstuff of the invention may include a flour or a meal with various particle sizes. It is intended that the term “flour” as used herein refers to a flour or a meal with various particle sizes. Suitable flours include starch-based flour such as whole wheat flour, enriched flour, corn flour, potato flour, rice flour, oat flour, barley flour, corn meal, and the like.

In some embodiments of the invention, a casing component may include up to 30%, up to 35%, up to 40%, up to 45%, up to 50 wt %, up to 55 wt %, up to 60 wt %, up to 65 wt %, up to 70 wt %, up to 75 wt %, up to 80 wt %, up to 85 wt %, or up to 90 wt % flour of the total weight of all ingredients in the casing component.

In some embodiments, a casing component may include from about 40% to about 95%, from about 37% to about 92%, from about 50 wt % to about 90 wt %, from about 55 wt % to about 90 wt %, from about 60 wt % to about 85 wt %, from about 65 wt % to about 80 wt %, or from about 70 wt % to about 75 wt % flour of the total weight of all ingredients in the casing component.

In some embodiments, a casing component may include from about 40% to about 50%, from about 50 wt % to about 60 wt %, from about 60 wt % to about 70 wt %, from about 70 wt % to about 80 wt %, from about 80 wt % to about 90 wt %, from about 40 wt % to about 60 wt %, from about 50 wt % to about 70 wt %, from about 60 wt % to about 80 wt %, or from about 70 wt % to about 90 wt % flour of the total weight of all ingredients in the casing component.

In some embodiments, a casing component may include about 40 wt %, about 45 wt %, about 50 wt %, about 55 wt %, about 60 wt %, about 62%, about 65 wt %, about 67%, about 70 wt %, about 72%, about 75 wt %, about 77%, about 80 wt %, about 82%, about 85 wt %, about 95 wt %, or about 95 wt % flour of the total weight of all ingredients in the casing component.

In some embodiments of the invention, a casing component may include at least 50 wt %, at least 55 wt %, at least 60 wt %, at least 65 wt %, at least 70 wt %, at least 75 wt %, at least 80 wt %, at least 85 wt %, or at least 90 wt % flour of the total weight of all ingredients in the casing component.

In some embodiments a flour component of a casing component consists essentially of wheat flour.

In some embodiments a flour component of a casing component comprises at least 10%, 15%, 20%, 25%, 30%, 35%, 40%, 45%, 50 wt %, 55 wt %, 60 wt %, 65 wt %, 70 wt %, 75 wt %, 80 wt %, 85 wt %, 90 wt %, or 95 wt % wheat flour.

In some embodiments a flour component of a casing component comprises from about 9.3 wt % to about 73.6 wt %, from about 0 wt % to about 100 wt %, from about 10% to about 90%, from about 10 wt % to about 40 wt %, from about 10 wt % to about 50 wt %, from about 10 wt % to about 30 wt %, from about 10 wt % to about 20 wt %, from about 20% to about 90%, from about 20% to about 75%, from about 10% to about 50%, from about 20 wt % to about 40 wt %, from about 20 wt % to about 30 wt %, from about 70 wt % to about 95 wt %, from about 60 wt % to about 85 wt %, from about 95 wt % to about 100 wt %, from about 0 wt % to about 10 wt %, or from about 90 wt % to about 95 wt % wheat flour.

In some embodiments a flour component of a casing component comprises up to 100 wt %, 95 wt %, 90 wt %, 85 wt %, 80 wt %, 75 wt %, 70 wt %, 65 wt %, 60 wt %, 55 wt %, 50 wt %, 45 wt %, or 40 wt % wheat flour.

In some embodiments a flour component of a casing component comprises about 100 wt %, about 95 wt %, about 90 wt %, about 85 wt %, about 80 wt %, about 75 wt %, about 70 wt %, about 65 wt %, about 60 wt %, about 55 wt %, about 50 wt %, about 45 wt %, about 40 wt %, about 35%, about 30%, about 25%, about 20%, about 15%, about 10%, about 5%, or about 0% wheat flour.

In some embodiments a flour component may comprise a two or more different types of flour. For example, a flour component may comprise wheat flour and non-wheat flour, where non-wheat flour includes one or more of corn flour, potato flour, rice flour, oat flour, and barley flour. In some embodiments a non-wheat flour includes one or more of corn flour, potato flour, and rice flour.

In some embodiments, a flour component may comprise up to 100%, up to 80%, up to 70% up to 60%, up to 50%, up to 40%, up to 30%, up to 25%, up to 20%, up to 15%, up to 10%, or up to 5% by weight of a non-wheat flour that includes at least one of rice flour, corn flour, potato flour, barley flour, and oat flour.

In some embodiments, a flour component may comprise greater than 0%, greater than 5%, greater than 10%, greater than 15%, greater than 20%, greater than 25%, greater than 30%, greater than 40%, or greater than 50% by weight of a non-wheat flour.

In some embodiments, a flour component may comprise from about 0% to about 100%, from about 0 wt % to about 50 wt %, from about 0 wt % to about 25 wt %, from about 0 wt % to about 20 wt %, from about 0 wt % to about 15 wt %, from about 0 wt % to about 10 wt %, from about 0 wt % to about 5 wt %, from about 5 wt % to about 10 wt %, or from about 10 wt % to about 30% by wt % of non-wheat flour.

In some embodiments, a flour component may comprise about 2 wt %, about 3 wt %, about 5 wt %, about 10 wt %, about 15 wt %, about 20 wt %, about 25 wt %, about 30 wt %, about 40 wt %, about 50 wt %, about 60 wt %, about 70 wt %, about 80 wt % or about 90 wt % of non-wheat flour.

In some embodiments a flour component of a co-extruded snack product comprises from about 9.3% to about 73.6%, from about 10% to about 90%, from about 10 wt % to about 40 wt %, from about 10 wt % to about 50 wt %, from about 10 wt % to about 30 wt %, from about 10 wt % to about 20 wt %, from about 20% to about 90%, from about 20% to about 75%, from about 10% to about 50%, from about 20 wt % to about 40 wt %, from about 20 wt % to about 30 wt %, from about 70 wt % to about 95 wt %, from about 60 wt % to about 85 wt %, from about 95 wt % to about 100 wt %, or from about 90 wt % to about 95 wt % by weight of a co-extruded snack product.

In some embodiments a flour component of a co-extruded snack product comprises about 9%, about 10%, about 15%, about 20%, about 25%, about 30 wt %, about 35%, about 40 wt %, about 45%, about 50 wt %, about 55%, about 60 wt %, about 65%, about 70 wt %, about 73%, or about 75% by weight of a co-extruded snack product.

Cocoa

The casing components of embodiments of the invention can include a cocoa. In some embodiments, the casing component can include cocoa in an amount from about 5% to about 30% by weight, from about 7% to about 25% by weight, from about 9% to about 18% by weight, from about 10% to about 15% by weight cocoa, from about 15% to about 17% by weight cocoa, about 10% by weight, about 11% by weight, about 12% by weight, about 13% by weight, about 14% by weight, about 15% by weight or about 16% by weight cocoa, of the casing component.

In some embodiments a cocoa component of a co-extruded snack product comprises from about 0% to about 25%, from about 1% to about 24%, from about 5 wt % to about 20 wt %, from about 1 wt % to about 10 wt %, from about 5 wt % to about 15 wt %, from about 10% to about 20%, from about 15 wt % to about 25 wt %, or from about 20% to about 30%, by weight of a co-extruded snack product.

In some embodiments a cocoa component of a co-extruded snack product comprises about 1%, about 2%, about 3%, about 4 wt %, about 5 wt %, about 6 wt %, about 7 wt %, about 8 wt % to about 9 wt %, about 10%, about 15%, about 20%, or about 25 wt % by weight of a co-extruded snack product.

Sweeteners

In some embodiments, the casing component includes one or more sweeteners, to produce a selected taste and/or texture. Examples of optional sweeteners include high-intensity artificial sweeteners, such as maltitol, polydextrose, saccharin, sucralose, acesulfame potassium, and aspartame, and natural sugars or sweeteners such as granulated sugar, fructose, glucose, sucrose, dextrose, corn syrup, high fructose corn syrup, corn syrup solids, honey, and the like. In some embodiments of the invention, sugars or sweeteners can be employed in amounts up to about 25% by weight of the casing component, and preferably about 15% by weight of the casing component.

In some embodiments a sweetener component of a casing component consists essentially of sugar (e.g. granulated sugar).

In some embodiments, a casing component comprises up to 3 wt %, up to 5 wt %, up to 7 wt %, up to 10 wt %, up to 13 wt %, up to 15 wt %, up to 18 wt %, up to 20 wt %, up to 23 wt %, up to 25 wt %, or up to 30 wt % sweetener (e.g. sugar, granulated sugar) of the total weight of the casing component.

In some embodiments, a casing component comprises less than 30 wt %, less than 28 wt %, less than 25 wt %, less than 23 wt %, less than 20 wt %, less than 18 wt %, less than 15 wt %, less than 13 wt %, less than 10 wt %, less than 8 wt %, or less than 5 wt % sweetener (e.g. sugar, granulated sugar) of the total weight of the casing component.

In some embodiments, a casing component comprises about 3%, about 4%, about 5%, about 6%, about 7%, about 8 wt %, about 9%, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, or about 22 wt % sweetener (e.g. sugar, granulated sugar) of the total weight of the casing component.

In some embodiments, a casing component comprises from about 1 wt % to about 30 wt %, from about 3% to about 30%, from about 5 wt % to about 25 wt %, from about 10 wt % to about 20 wt %, from about 12 wt % to about 18 wt %, from about 10 wt % to about 20 wt %, from about 12 wt % to about 18 wt %, from about 3 wt % to about 30 wt %, from about 5 wt % to about 15 wt %, or from about 15 wt % to about 25 wt % sweetener (e.g. sugar, granulated sugar) of the total weight of the casing component.

In some embodiments, a co-extruded snack product comprises about 0.5 wt %, about 1%, about 2 wt %, about 3 wt %, about 4 wt %, about 5 wt %, about 6 wt %, about 7 wt %, about 8 wt %, about 9 wt %, about 10 wt %, about 15 wt %, about 20 wt %, or about 25 wt % sweetener (e.g. sugar, granulated sugar) of the total weight of the co-extruded snack product.

In some embodiments, a co-extruded snack product comprises from about 0.5 wt % to about 25 wt %, from about 1 wt % to about 20 wt %, from about 5 wt % to about 15 wt %, from about 1 wt % to about 5 wt %, from about 5 wt % to about 10 wt %, from about 10 wt % to about 15 wt %, from about 15 wt % to about 20 wt %, from about 20 wt % to about 25 wt %, from about 1 wt % to about 10 wt %, from about 5 wt % to about 15 wt %, or from about 10 wt % to about 20 wt % sweetener (e.g. sugar, granulated sugar) of the total weight of the co-extruded snack product.

Additional Ingredients

In some embodiments, additional ingredients may be included in the casing component based on, for example, desired taste, nutrition, texture, and visual appeal of the casing component. Exemplary additional ingredients include, but are not limited to, whole grains, non-whole grains, fiber, leavening agents, sweetening agents, flavor and/or texture inclusions, salt, protein, colors, preservatives, and combinations thereof.

The casing components of the present invention may contain a leavening system. The leavening system may be included in an amount of up to about 2.5 wt % of the casing component, and preferably in an amount of up to about 1 wt % of the casing component, based upon the weight of the casing dry powder blend prior to cooking/extruding. Exemplary chemical leavening agents or pH-adjusting agents which may be used include alkaline materials and acidic materials such as sodium bicarbonate, ammonium bicarbonate, calcium acid phosphate, calcium phosphate monobasic, sodium acid pyrophosphate, diammonium phosphate, tartaric acid, mixtures thereof, and the like.

In addition to, or in substitution of one or more of the foregoing, the casing component employed in some embodiments of the present invention may include other additives conventionally employed in crackers, cookies, or cereals. Such additives may include, for example, protein sources, such as dairy by-products, enzyme modified milk powder, whey, egg or egg by-products, soy or soy isolates, and the like; cocoa, vanilla, vanillin, mint, coffee, or other flavorings; flour substitutes or bulking agents, such as polydextrose, hollocellulose, microcrystalline cellulose, mixtures thereof, and the like; starches such as pre-gelatinized starch and potato starch, and the like; antimycotics or preservatives, such as calcium propionate, potassium sorbate, sorbic acid, and the like; emulsifiers, such as mono- and di-glycerides, polyoxyethylene sorbitan fatty acid esters, lecithin, stearoyl lactylates, and the like; processing aids, such as high oleic canola oil, soybean oil, safflower oil, palm oil, and/or derivatives thereof, and/or solid fats such as shortening, and the like; as well as inclusions or particulates that are appropriately sized to be extruded through a die without clogging the extruder or the die, and can withstand the high temperatures of the cooking/extrusion process, in conventional amounts.

The inclusion of any amount of any additional ingredients, such as those described above, in the casing component may be adjusted according to the desired taste and texture of the casing component within the scope of the invention.

Filling

In some embodiments an extruded filling can be disposed within an extruded casing component of a co-extruded foodstuff. Preferably, the casing component covers substantially the entire surface of the filling.

Any conventional filler for a snack product that is capable of being extruded through an extrusion die without clogging the extruder or die may be used. The filling can comprise crème, jelly, peanut butter, jam, chocolate, pudding, caramel, spices or seasonings such as cinnamon, cheese, or other edible filler materials, and mixtures thereof. Fillings can include flavorings or other additives such as vanilla or vanillin, mint, fruit extracts, nut extracts, or coffee. Preferred fillings include crème fillings and chocolate fillings, such as a chocolate crème filling. A crème filling can be any conventional crème filling and can include a sweetener, a fat, a flavoring, an emulsifier, or any combination thereof. In some embodiments a filling can include particulates as described below, e.g baked crumbs.

In some embodiments, a co-extruded foodstuff includes an extruded filling disposed within an extruded casing, wherein the extruded foodstuff comprises about 30 wt %, about 35 wt %, about 40 wt %, about 45 wt %, about 50 wt %, about 55 wt %, about 60 wt %, about 65 wt %, about 70 wt %, about 75 wt %, or about 80 wt % filling of the total weight of the extruded foodstuff.

In some embodiments, a co-extruded foodstuff includes an extruded filling disposed within an extruded casing, wherein the extruded foodstuff comprises at least 20 wt %, at least 30 wt %, at least 35 wt %, at least 40 wt %, at least 45 wt %, at least 50 wt %, at least 55 wt %, at least 60 wt %, at least 65 wt %, or at least 70 wt %, filling of the total weight of the extruded foodstuff.

In some embodiments, a co-extruded foodstuff includes an extruded filling disposed within an extruded casing, wherein the extruded foodstuff comprises up to 50 wt %, up to 55 wt %, up to 60 wt %, up to 65 wt %, up to 70 wt %, up to 75 wt %, or up to 80 wt % filling of the total weight of the extruded foodstuff.

In some embodiments, a co-extruded foodstuff includes an extruded filling disposed within an extruded casing, wherein the extruded foodstuff comprises about 20% to about 75%, about 30 wt % to about 50 wt %, about 40 wt % to about 60 wt %, about 50 wt % to about 70 wt %, about 60 wt % to about 80 wt %, about 70 wt % to about 90 wt %, about 30 wt % to about 90 wt %, about 35 wt % to about 85 wt %, about 40 wt % to about 80 wt %, about 45 wt % to about 75 wt %, about 50 wt % to about 70 wt %, or about 55 wt % to about 65 wt % filling of the total weight of the extruded foodstuff.

In some embodiments, a co-extruded foodstuff includes an extruded filling disposed within an extruded casing wherein the ratio of filling weight to casing weight of the extruded foodstuff is at least 2:1, 1.9:1, 1.8:1, 1.7:1, 1.6:1,1.5:1, 1.4:1, 1.3:1, 1.2:1, 1.25:1, 1.1:1, 1:1, 1:1.1, 1:1.2, or 1:1.25.

In some embodiments, a co-extruded foodstuff includes an extruded filling disposed within an extruded casing wherein the ratio of filling weight to casing weight of the extruded foodstuff is less than 2:1, 1.9:1, 1.8:1, 1.7:1, 1.6:1,1.5:1, 1.4:1, 1.3:1, 1.2:1, 1.25:1, 1.1:1, or 1:1.

In some embodiments, a co-extruded foodstuff includes an extruded filling disposed within an extruded casing wherein the ratio of filling weight to casing weight of the extruded foodstuff is about 4:1, about 3.5:1, about 3:1, about 2.5:1, about 3.5:1.5, about 2:1, about 1.9:1, about 1.8:1, about 1.7:1, about 1.6:1, about 1.5:1, about 1.4:1, about 1.3:1, about 1.2:1, about 1.25:1, about 1.1:1, about 1:1, about 1:1.1, about 1:1.2, about 1:1.25, about 1:1.3, about 1:1.4, about 1:1.5, about 1:3, or about 1:4 by weight.

In some embodiments, a co-extruded foodstuff includes an extruded filling disposed within an extruded casing wherein the ratio of filling weight to casing weight of the extruded foodstuff is from 4:1 to about 1:4 by weight, about 3:1 to about 1:4 by weight, about 1:1.5 to about 3.5:1.5 by weight, about 2:1 to about 1:1 by weight, from about 2:1 to about 1.5:1 by weight, from about 2:1 to about 1.75:1 by weight, about 1.75:1 to about 1.5:1 by weight, from about 1.5:1 to about 1:1 by weight, from about 2:1 to about 1:1.5 by weight.

A filling can be characterized by its viscosity. As used herein, a viscosity measurement of a co-extruded snack product filling is made according to the Brookfield Method, which is used to determine the force required to rotate a spindle in a fluid, where the spindle is a #27 Spindle, the sample fluid is held at 50° C., and the spindle rotated at 20 RPM.

In some embodiments, a co-extruded snack product filling has a viscosity measurement between about 100 cP and about 50000 cP, between about 1000 cP and about 4000 cP, between about 1500 cP and about 35000 cP, between about 2000 cP and about 30000 cP, between about 2500 cP and about 25000 cP, between about 2000 cP and about 10000 cP, between about 5000 cP and about 15000 cP, between about 10000 cP and about 20000 cP, between about 15000 cP and about 25000 cP, or between about 20000 cP and about 30000 cP.

In some embodiments, a co-extruded snack product filling has a viscosity measurement of about 2000 cP, about 2500 cP, about 3000 cP, about 3500 cP, about 4000 cP, about 4500 cP, about 5000 cP, about 5500 cP, about 6000 cP, about 6500 cP, about 7000 cP, about 7500 cP, about 8000 cP, about 8500 cP, about 9000 cP, about 9500 cP, about 10000 cP, about 11000 cP, about 12000 cP, about 13000 cP, about 14000 cP, about 15000 cP, about 16000 cP, about 17000 cP, about 18000 cP, about 19000 cP, about 20000 cP, about 21000 cP, about 22000 cP, about 23000 cP, about 24000 cP, about 25000 cP, about 26000 cP, about 27000 cP, or about 30000 cP.

In some embodiments, a co-extruded snack product filling has a viscosity measurement of at least 2000 cP, at least 2500 cP, at least 3000 cP, at least 3500 cP, at least 4000 cP, at least 4500 cP, at least 5000 cP, at least 5500 cP, at least 6000 cP, at least 6500 cP, at least 7000 cP, at least 7500 cP, at least 8000 cP, at least 8500 cP, at least 9000 cP, at least 9500 cP, at least 10000 cP, at least 11000 cP, at least 12000 cP, at least 13000 cP, at least 14000 cP, at least 15000 cP, at least 16000 cP, at least 17000 cP, at least 18000 cP, at least 19000 cP, at least 20000 cP, at least 21000 cP, at least 22000 cP, at least 23000 cP, at least 24000 cP, or at least 25000 cP.

In some embodiments, a co-extruded snack product filling has a viscosity measurement of up to 2500 cP, up to 3000 cP, up to 3500 cP, up to 4000 cP, up to 4500 cP, up to 5000 cP, up to 5500 cP, up to 6000 cP, up to 6500 cP, up to 7000 cP, up to 7500 cP, up to 8000 cP, up to 8500 cP, up to 9000 cP, up to 9500 cP, up to 10000 cP, up to 11000 cP, up to 12000 cP, up to 13000 cP, up to 14000 cP, up to 15000 cP, up to 16000 cP, up to 17000 cP, up to 18000 cP, up to 19000 cP, up to 20000 cP, up to 21000 cP, up to 22000 cP, up to 23000 cP, up to 24000 cP, up to 25000 cP, up to 26000 cP, up to 27000 cP, or up to 30000 cP.

Particulate Component

Referring again to FIG. 1, a particulate component 110 may at least partially cover the external surface 115 of the casing component 105. While the particulate component, if present, preferably covers at least 80% of the external surface of the casing component, in some embodiments the particulate component covers at least about 20%, at least about 30%, at least about 40%, at least about 50%, at least about 60%, or at least 70% of the external surface 115 of the casing component 105. In some embodiments, particulate component 110 substantially completely covers external surface 115. In some embodiments, external surface 115 is visible between individual elements of particulate component 110.

In some embodiments a particulate component may form a part of the filling component, e.g., in some embodiments a filling component comprises a particulate component as described herein. In some embodiments a filling component comprises a particulate component that includes crumbs of a baked dough, such as baked cookie crumbs.

The particulate component may include particles of a cocoa (e.g., ground, crushed and/or milled cocoa). Suitable cocoas can include any type of cocoa useful in preparing extruded foodstuffs, including red cocoa, black cocoa, and high flavour cocoa (HFC), or a combination thereof. The particulate component may include a cocoa that consists essentially of HFC. In some embodiments, the particulate component may include a cocoa that consists essentially of red cocoa. In other embodiments, the particular component may include a cocoa that consists essentially of black cocoa. In still other embodiments, the particulate component may include a cocoa that consists essentially of HFC and red cocoa, or consists essentially of HFC and black cocoa. Preferably, the particulate component may include particles of at least one of HFC and red cocoa. For example, the particulate component may include particles of HFC and red cocoa, the particulate component may include particles of HFC and black cocoa, the particulate component may include particles of red cocoa and black cocoa, or the particulate component may include particles of red cocoa, black cocoa, and HFC.

The particulate component may include agglomerated particles. Agglomerated particles can include any particulate edible grouping of particles. In some embodiments, agglomerated particles can include ground particles of extrudate. In other embodiments, agglomerated particles can include particles of cookies, crackers, candy, sugars, salt, other dry flavors, particles of fruits and/or vegetables, dairy powders, or a combination thereof. In still other embodiments, agglomerated particles can include ground particles of baked dough, such as baked dough crumbs. Baked dough crumbs can be formed by grinding a baked dough foodstuff, such as a rotary molded, baked cookie or biscuit. Alternatively, the baked dough crumbs can be commercially available baked dough crumbs, such as cookie crumbs. The inclusion of baked dough crumbs in the extruded foodstuff of the invention may serve to evoke more of the taste and texture experience of a baked cookie product rather than an extruded product. For example, the baked dough crumbs may impart to the extruded foodstuff a crumbly texture or a tender texture, or a combination thereof.

The agglomerated particles within a particular component can vary in shape and size from one agglomerated particle to the next. Finely ground agglomerated particle may improve the adherence of the particulate component to the casing component. Use of finely ground agglomerated particle may also result in a smoother appearance of the coated extruded foodstuff and in a reduction in the messiness of the coated extruded foodstuff.

In some embodiments, the particulate component may further include particles that have a color that contrasts with the color of the casing. Such particles may be referred to as “glitter.” Any color that contrasts with the color of the casing is suitable, but in preferred embodiments the glitter is white. Glitter can comprise titanium dioxide and at least one of a gum, sugar, sweetener, gelatin, or polysaccharide.

The coated extruded food products of the invention preferably maintain the general shape of the casing component when the casing component is coated with the particulate component. That is, the coated extruded food products of the invention can take the shape of the casing component, for example, which can be generally spheroid, prolate spheroid, oblate spheroid, cylindrical, and pillow shaped. The particulate coating can impart a more crumby texture to the surface of the extruded foodstuff than is present in that of the casing component alone. Preferably, a co-extruded foodstuff of the invention including a casing component and a particulate component has a generally smooth appearance and leaves minimal crumb residue when handled.

Binder or Coating

In some embodiments the extruded foodstuff product can further include a binder or coating disposed over the external surface of the casing component. The binder or coating can serve to adhere the particulate component to the casing component. The binder may also serve to impart the desired level of tenderness and crumbliness to the coated extruded product to evoke the experience of a baked cookie product. The binder or coating can include a sugar or sugar syrup, corn syrup or high fructose corn syrup, polysaccharide, fat, dextrin, maltodextrin, gums, hydrocolloids or combination thereof. A sugar substitute may also be included in the binder. Sugar syrup can include any combination of sugar and water, for example a ratio of sugar to water by weight of from about 20:80 to about 80:20, 22:78 to about 78:22, 25:75 to about 75:25, 27:73 to about 73:27, 30:70 to about 70:30, 32:67 to about 67:32, 35:65 to about 65:35, 37:62 to about 62:37, and is preferably about 60:40. Example polysaccharides include maltodextrin. Exemplary fats include oils such as canola oil, soybean oil, safflower oil, palm oil, and/or derivatives thereof, and/or solid fats such as shortening. Preferably, the binder includes a fat, preferably palm oil or a modified palm oil. Use of a fat in a binder can result in a lighter, crispier texture of the coated extruded foodstuff than use of a sugar syrup. In some embodiments, appropriate selection of a binder and particulate component enhances the organoleptic properties of the foodstuff in terms of both texture and taste. For example, without wishing to be bound by any particular theory, in some embodiments, the friability of the extruded foodstuff when chewed imparts a texture that, to a consumer, is evocative of harder crunchier biscuits such as a rotary molded biscuit.

In some embodiments a co-extruded snack product comprises about 0% to about 1% , about 0% to about 0.5%, about 0% to about 1.5%, about 0% to about 2%, about 0.1% to about 1%, about 0.1% to about 0.5%, about 0.5% to about 1%, or about 0.2% to about 0.8% by weight coating or binder. In some embodiments a co-extruded snack product comprises about 0.1%, about 0.2%, about 0.3%, about 0.4%, about 0.5%, about0.6%, about 0.7%, about 0.8%, about 0.9%, or about 1% by weight coating or binder.

Method

Any method of extruding a rope to form a casing component known to persons of skill in the art can be used, including methods of co-extruding a filling and a casing component.

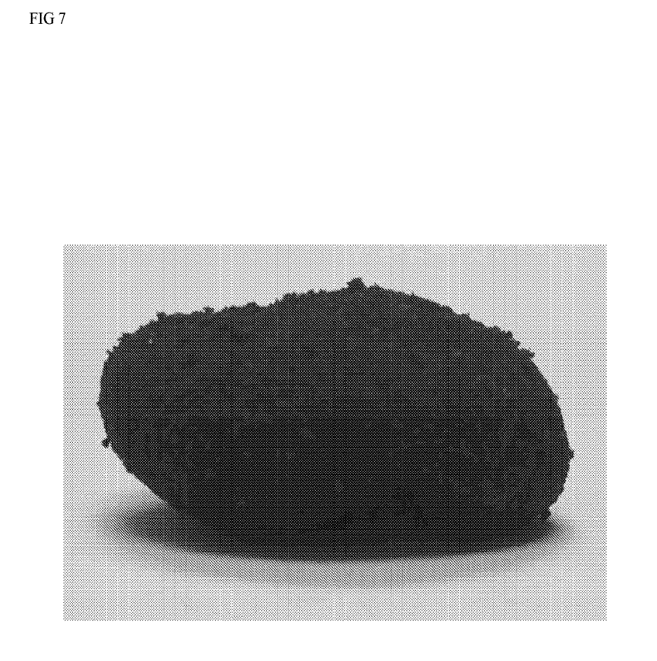

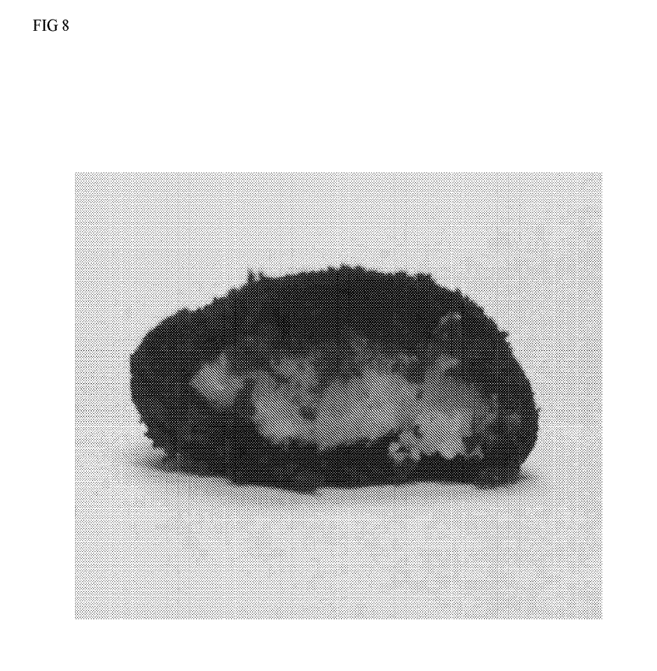

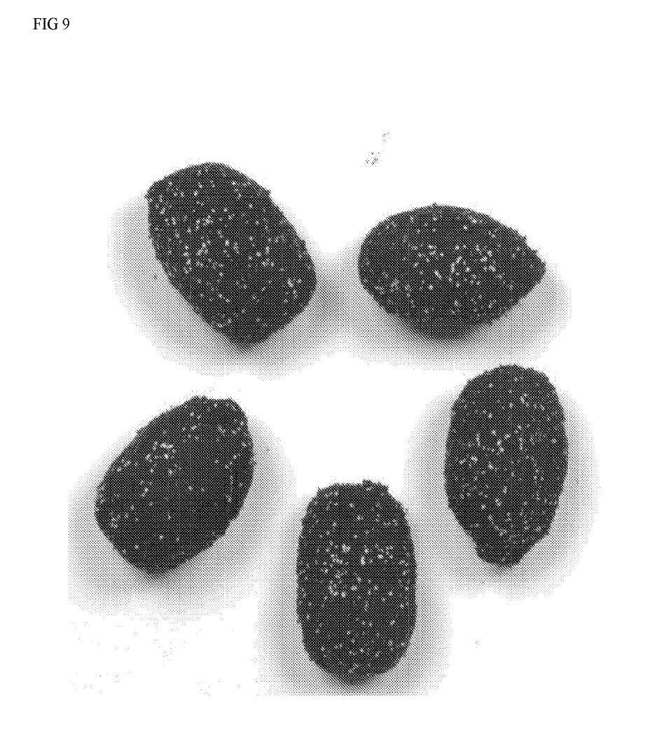

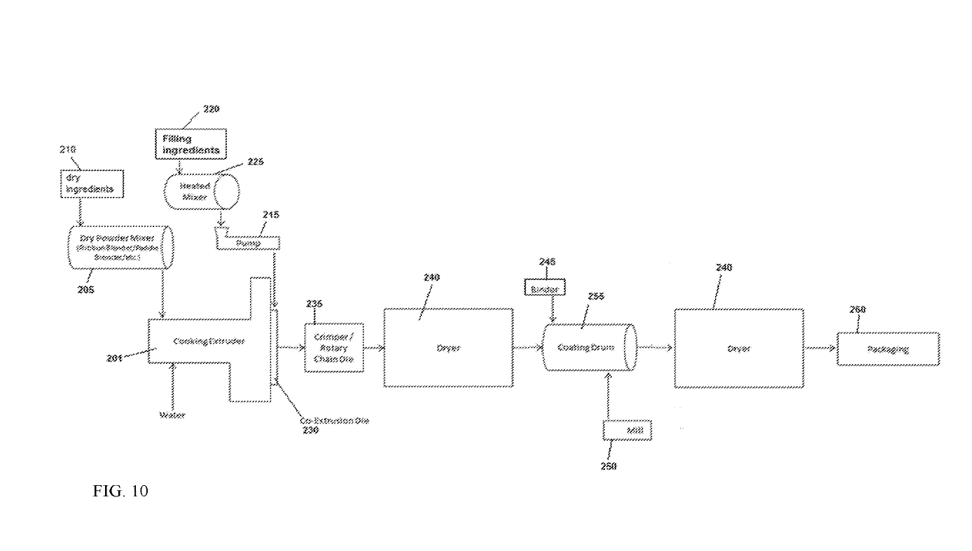

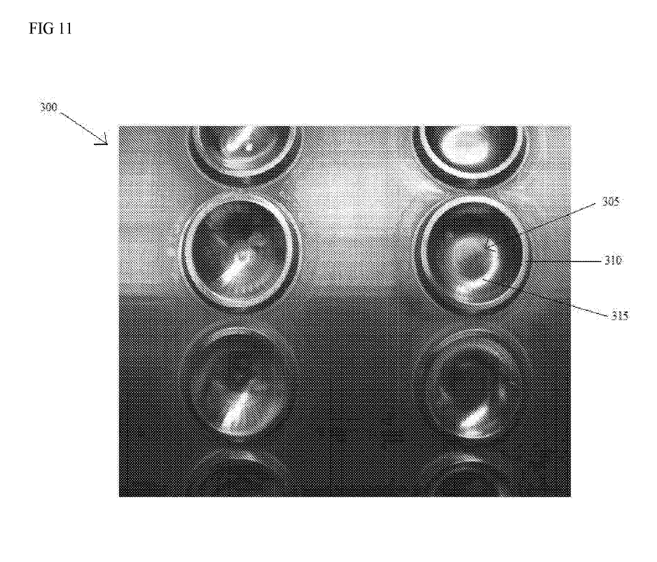

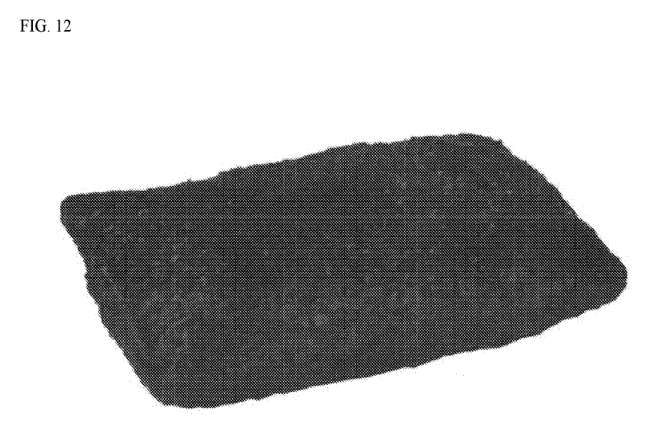

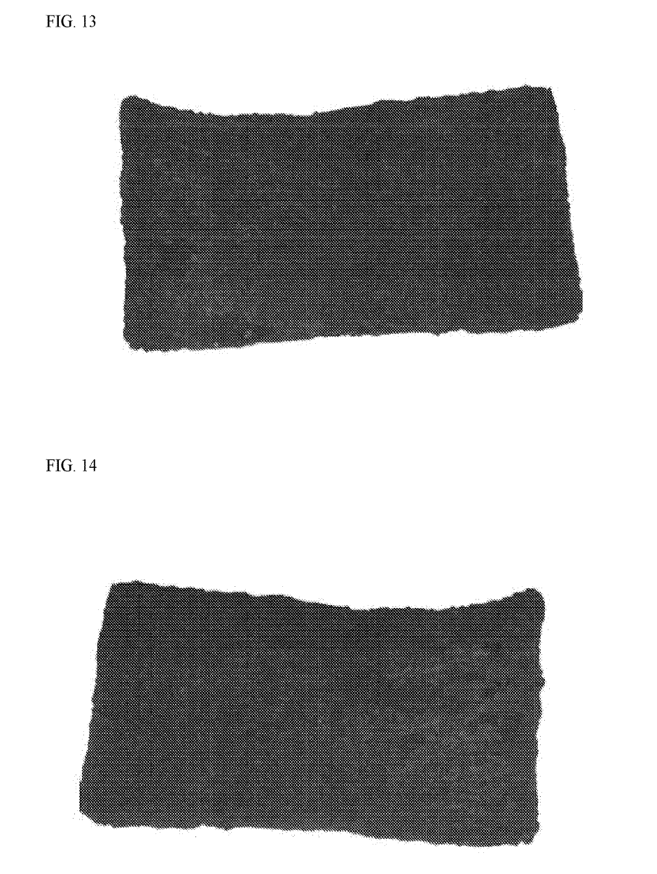

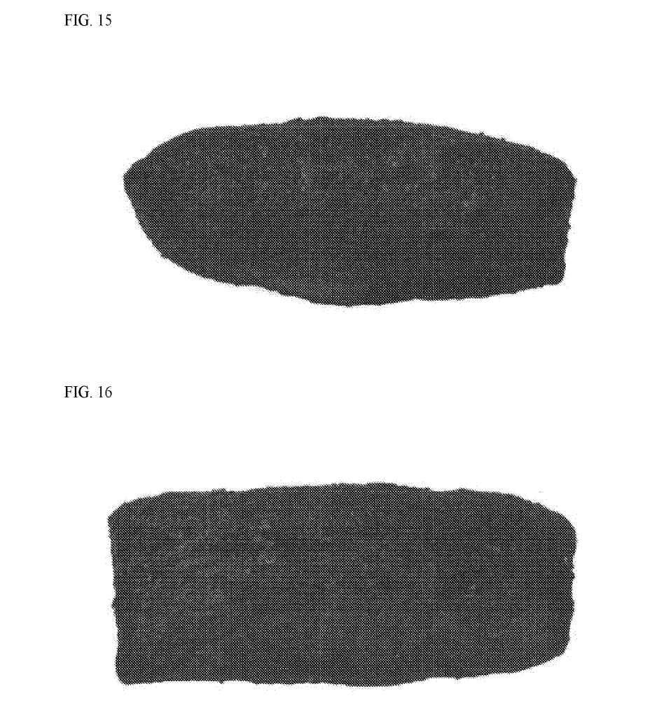

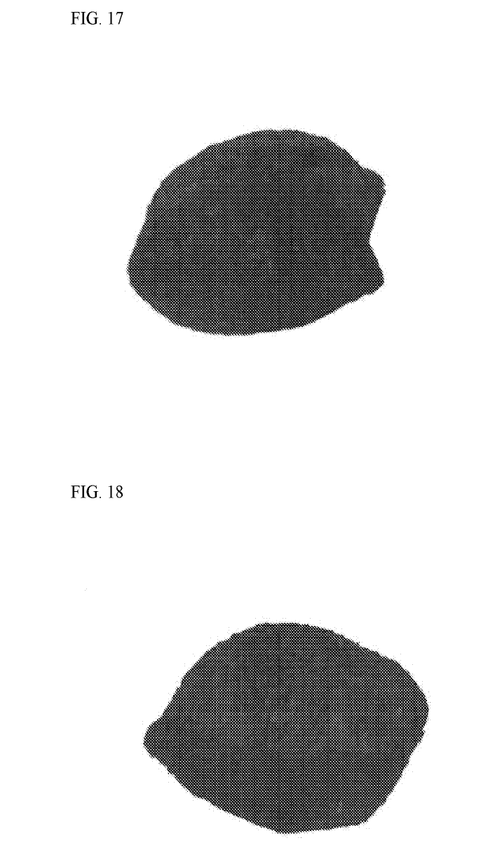

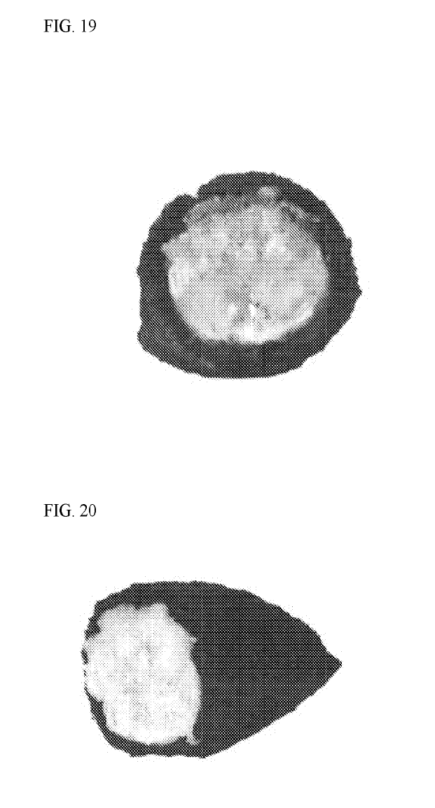

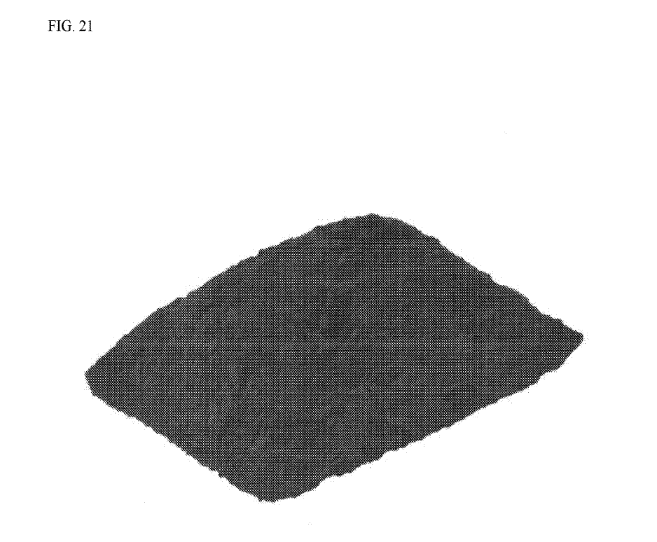

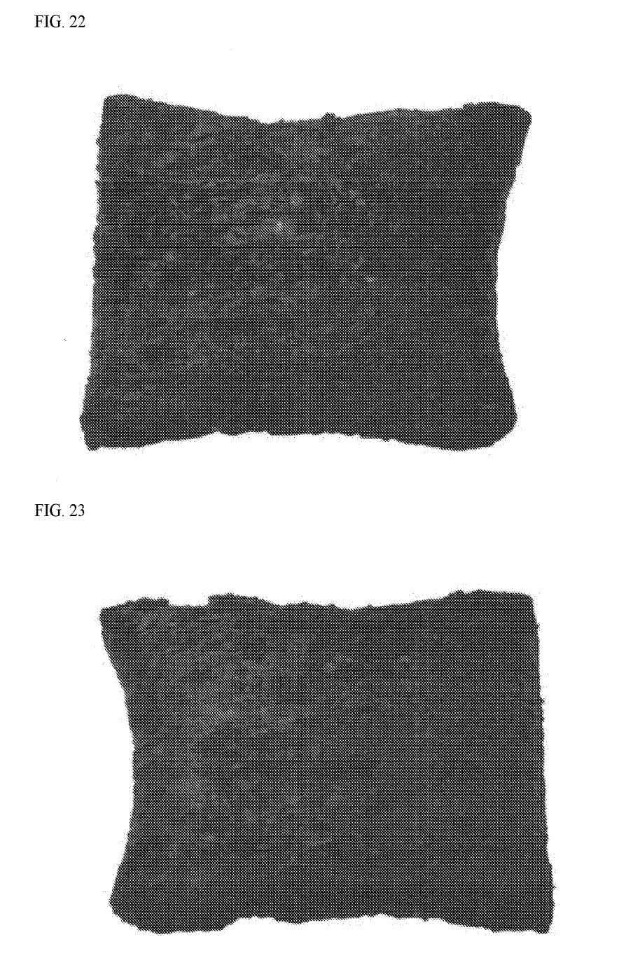

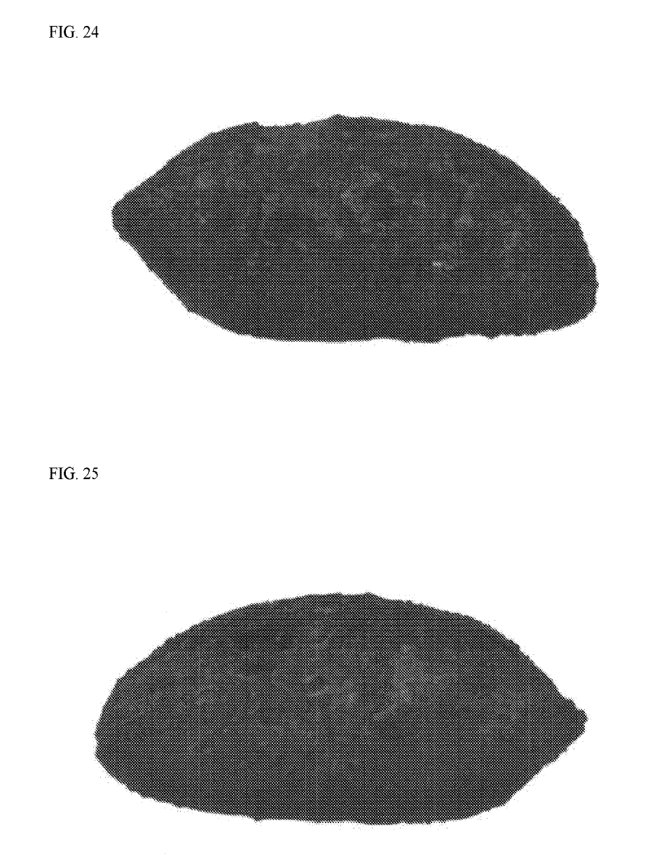

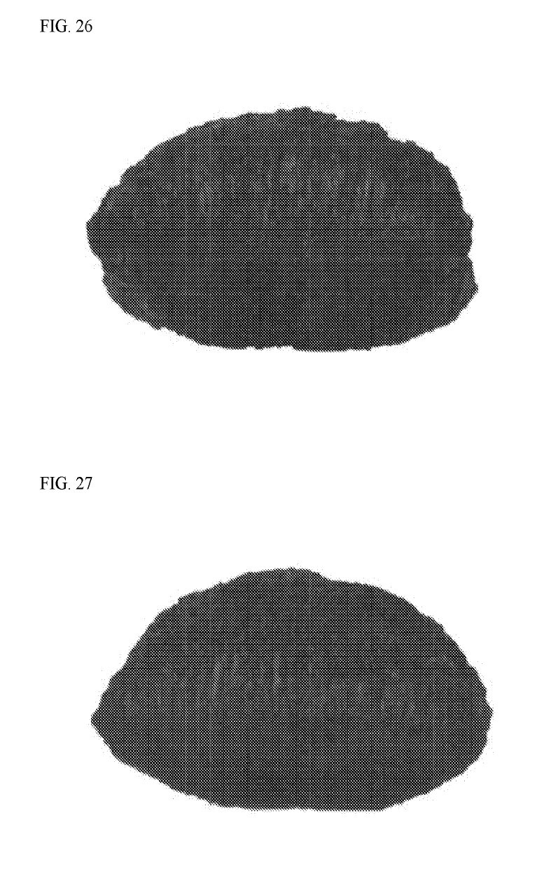

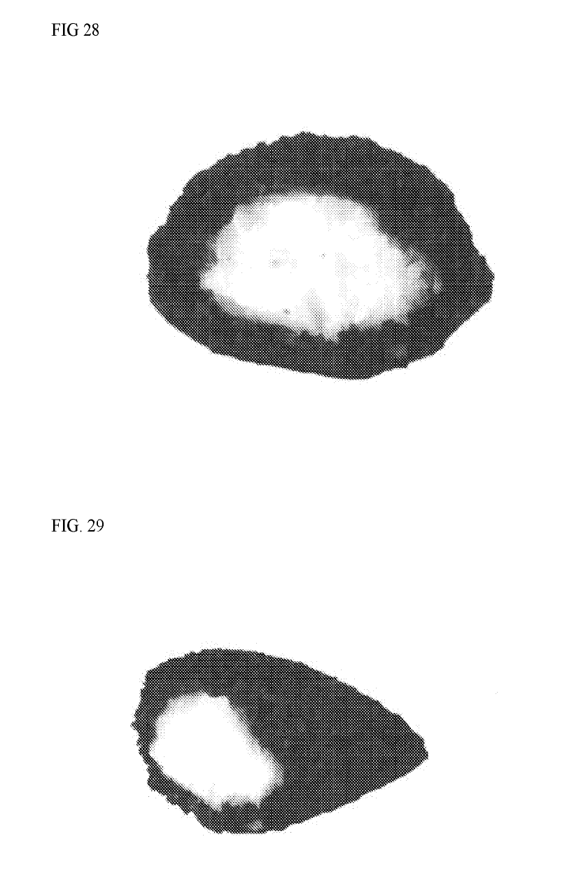

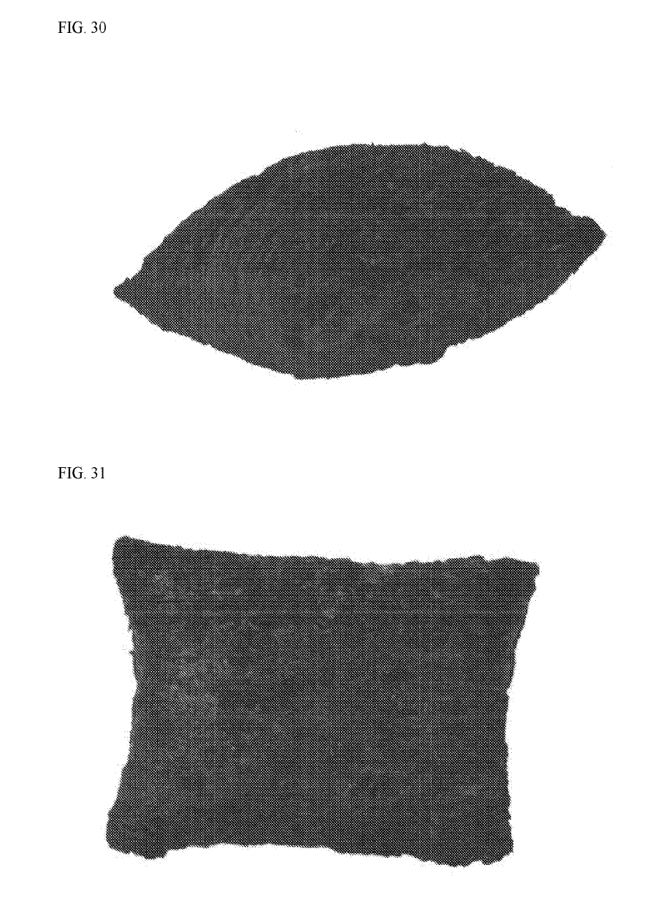

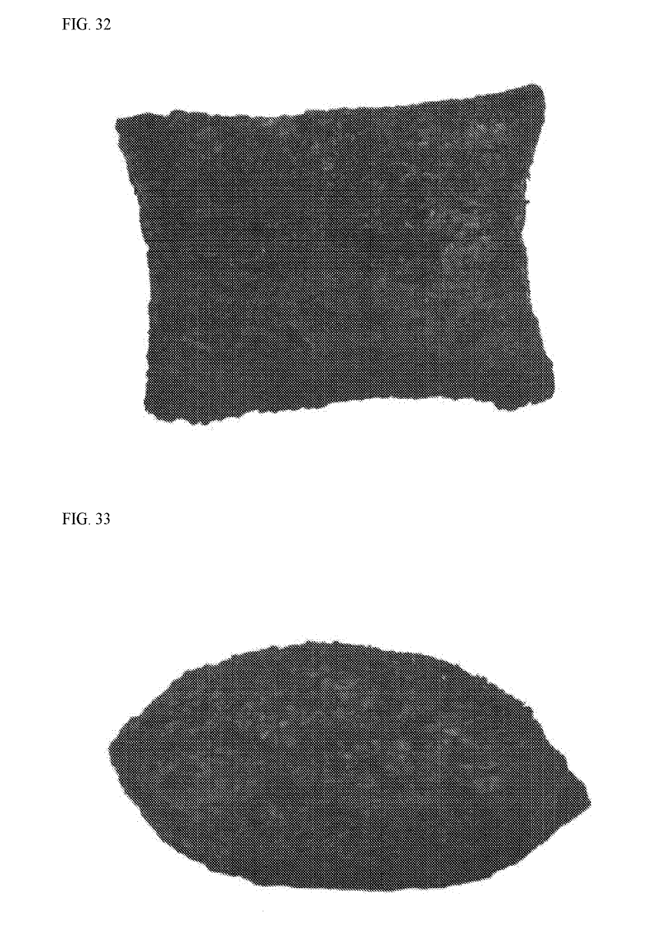

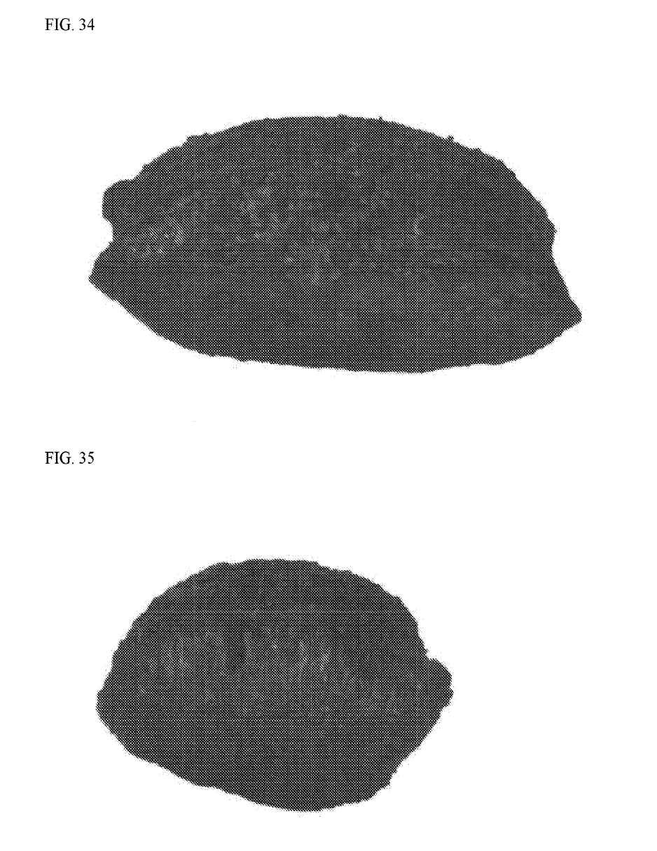

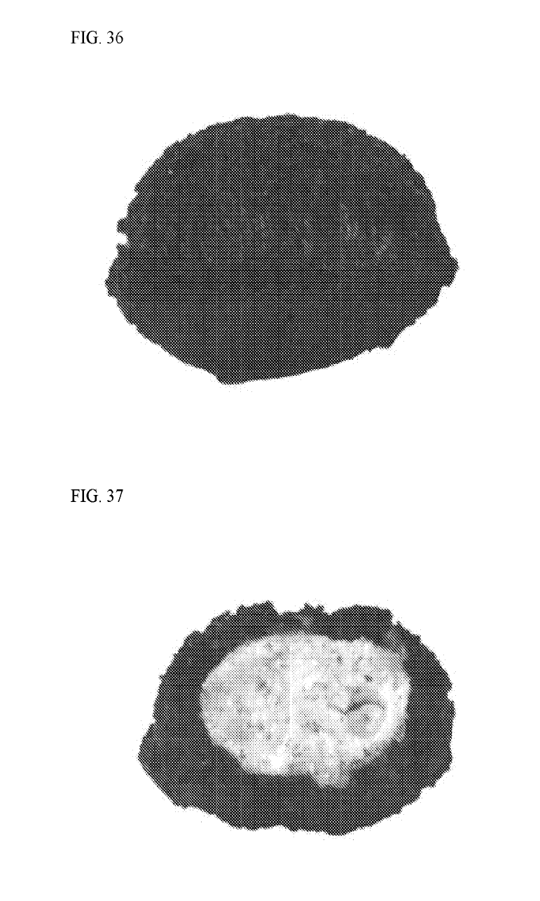

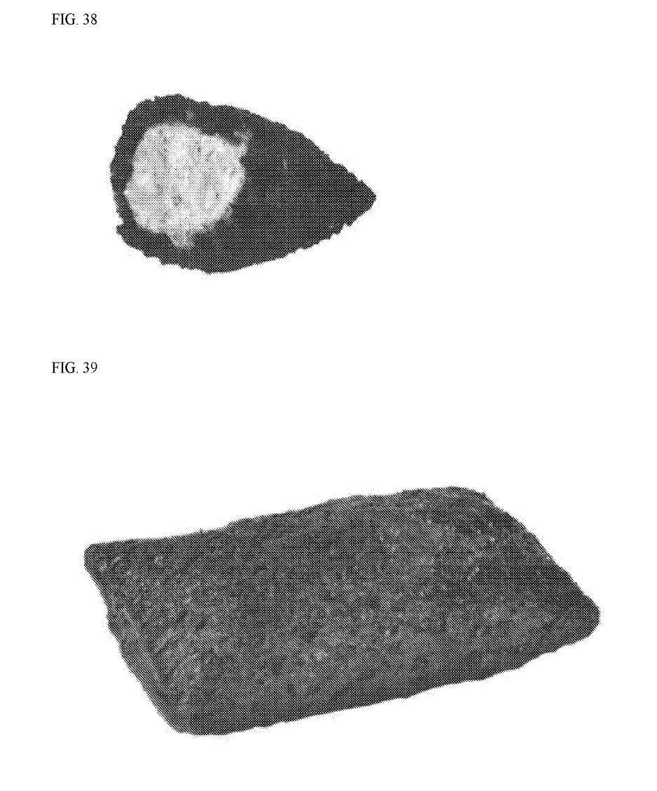

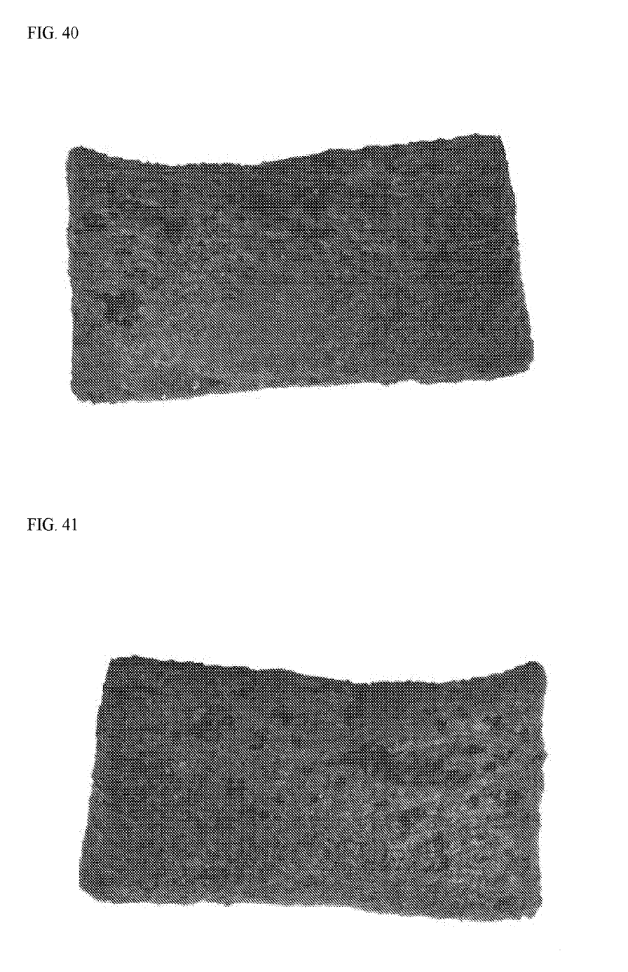

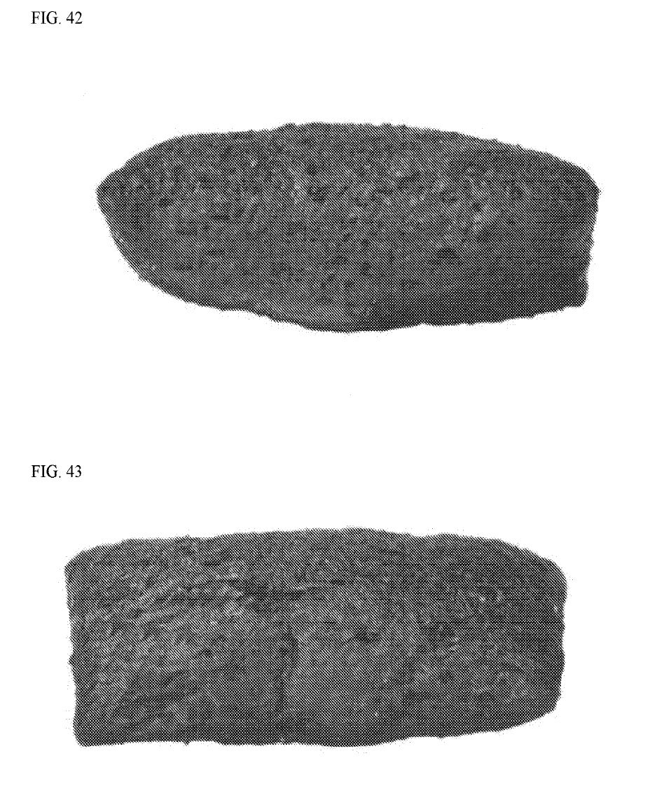

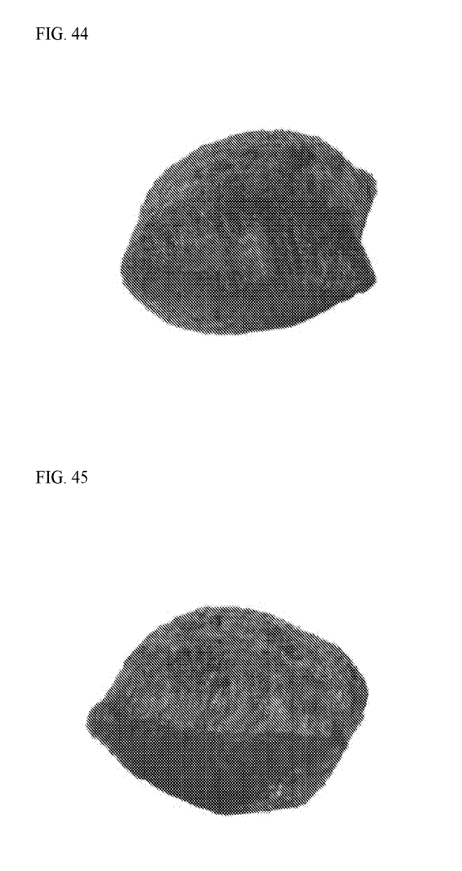

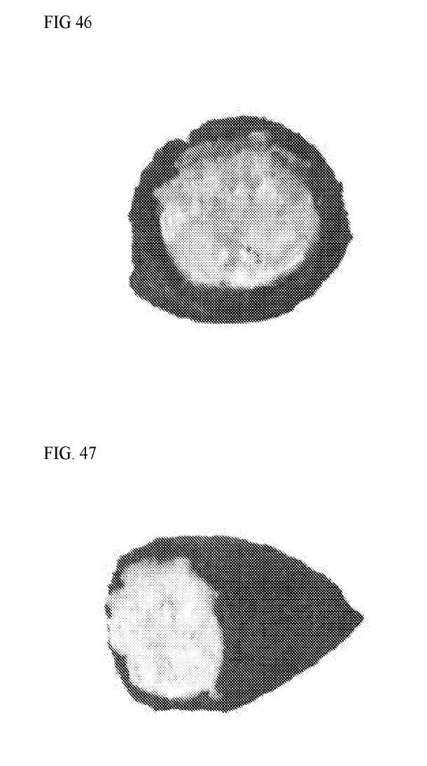

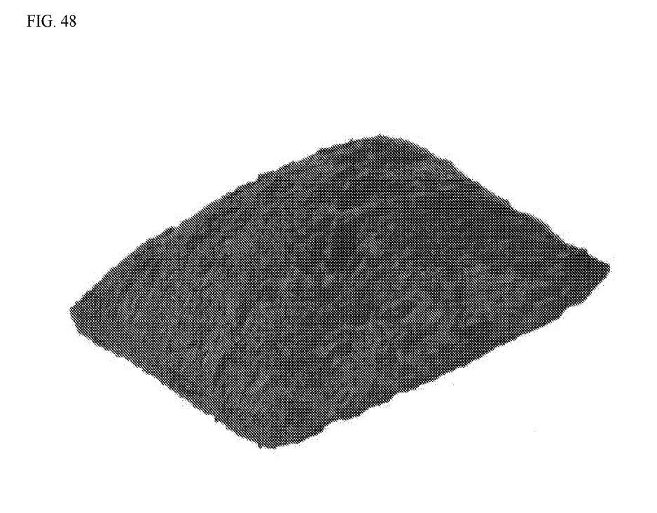

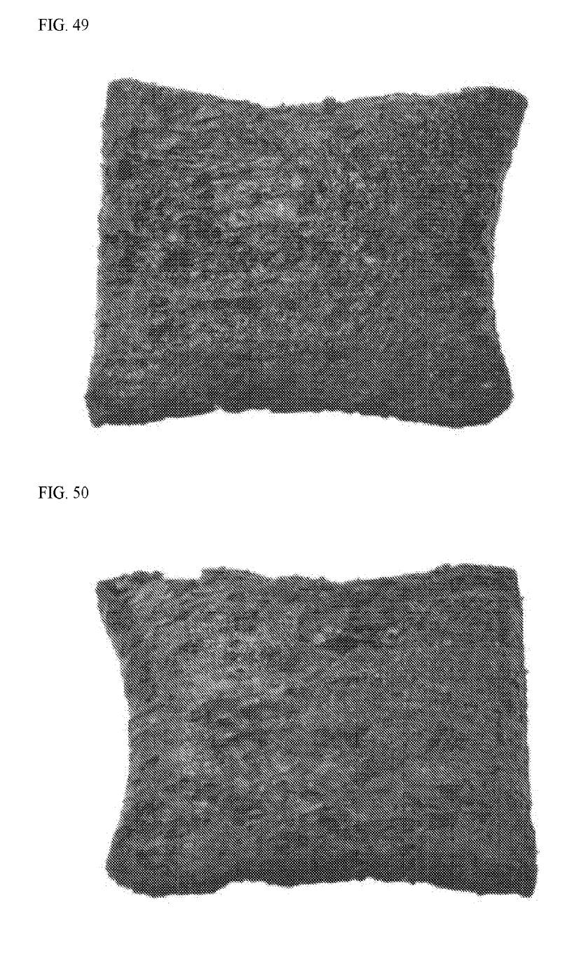

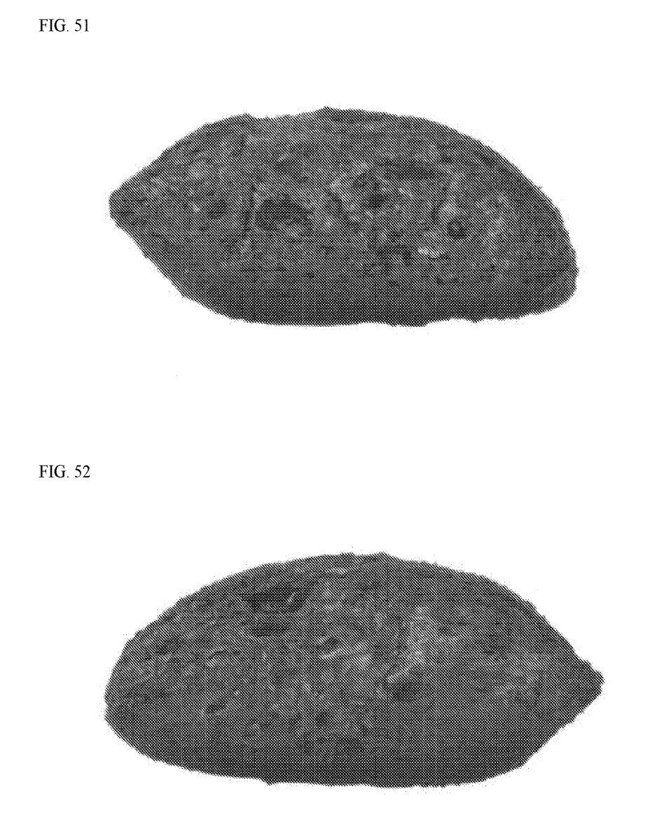

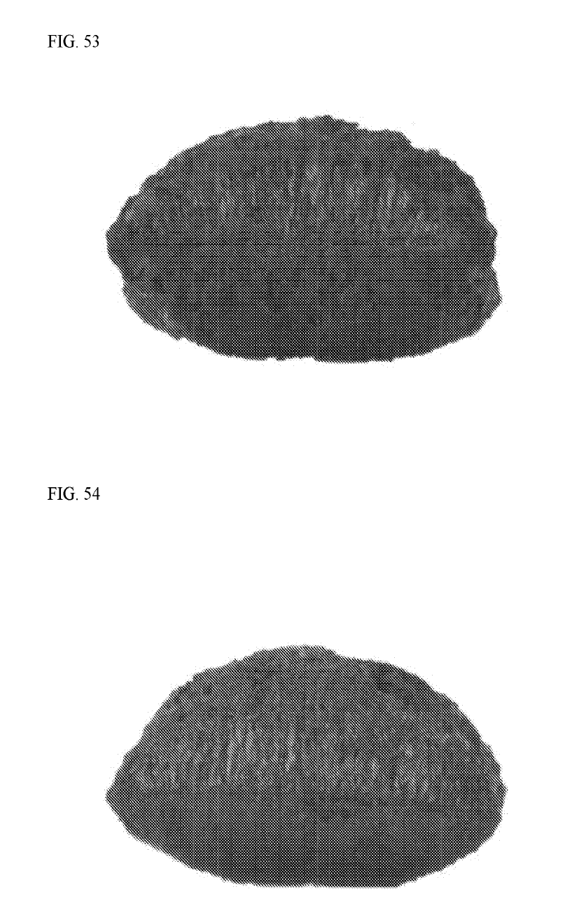

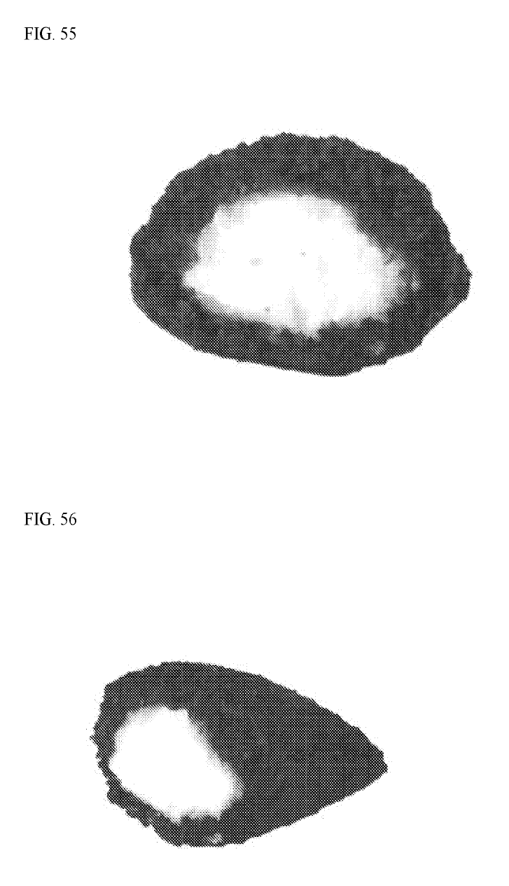

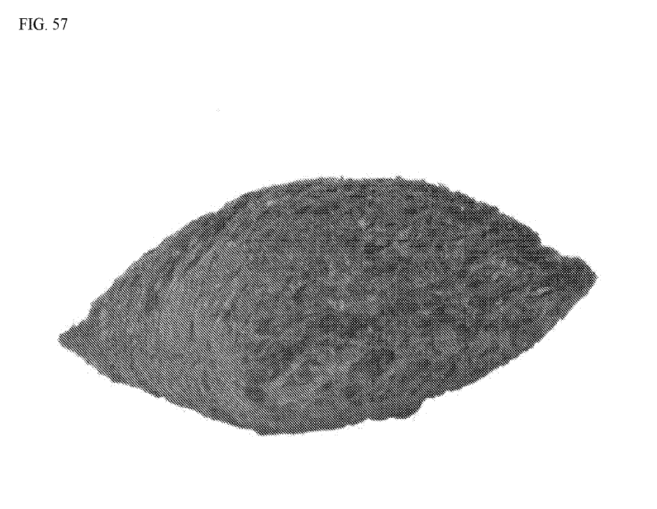

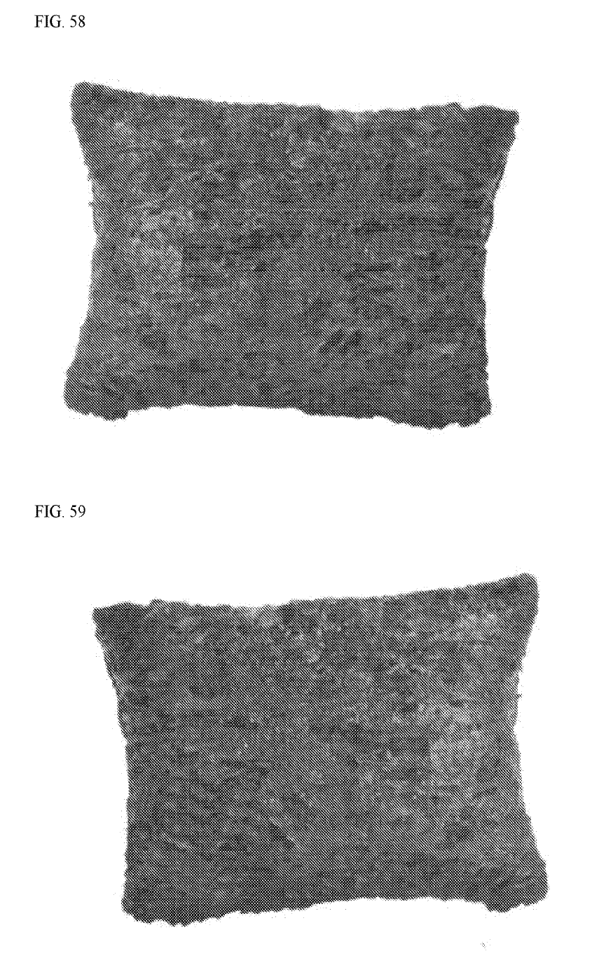

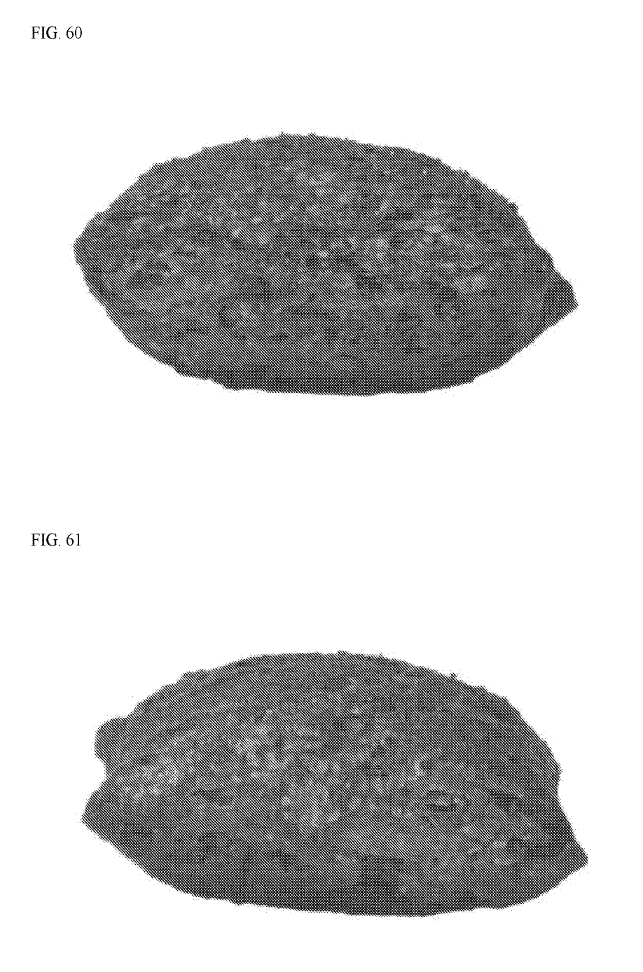

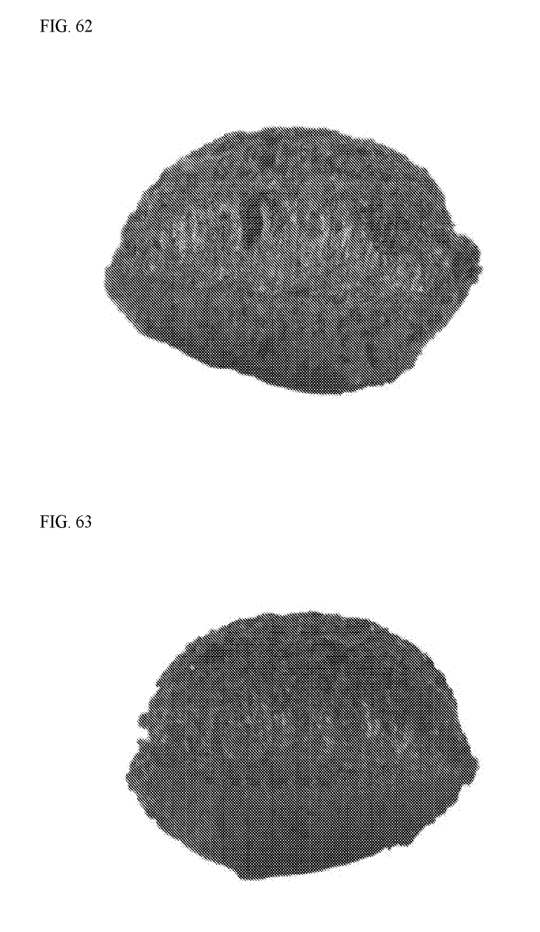

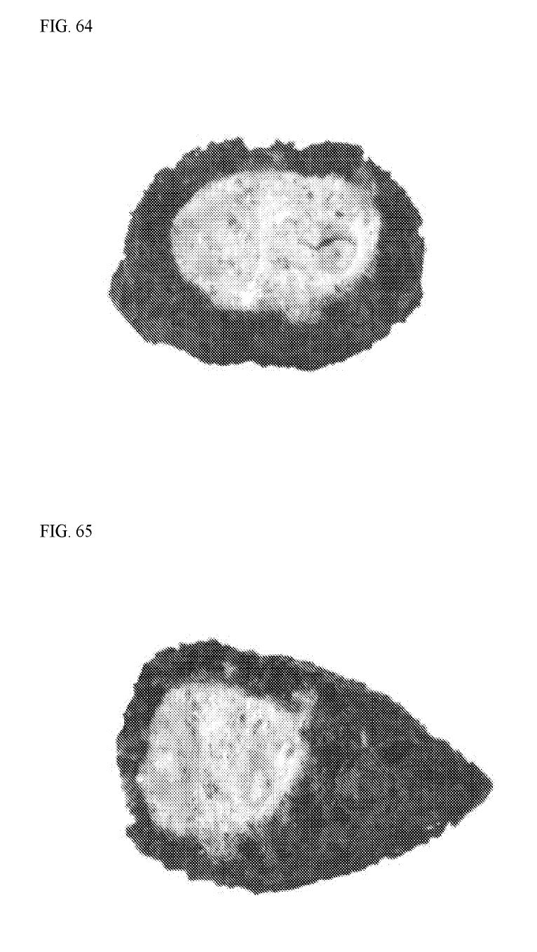

Referring to FIG. 10, the casing component can be made by placing ingredients in a cooking extruder 201. In some embodiments the dry ingredients 205 can be mixed separately from any wet ingredients before each is placed in the cooking extruder. Dry ingredients 205 can be mixed, for example, using a ribbon blender, paddle blender, or any other blender or mixer 210 suitable for combining dry ingredients. The ingredients placed in the cooking extruder can be mixed, heated, and/or compressed and pressed through an extrusion die 230 to form a ribbon. A ribbon as used herein can refer to a rope of any shape including tubular or flat. In embodiments in which a filling is to be disposed inside the casing component, a pump 215 can be used to pump the filling into the casing component extrudate as it exits the cooking extruder and the two components can be co-extruded through an extrusion die 230 to form a co-extruded ribbon. In some embodiments, the ingredients 220 of the filling component are heated and or mixed in a mixer 225 before being pumped into the casing component extrudate. For simplicity, in describing further steps, “extruded ribbon” can include casing component extrudate with a filling or without a filling.

In some embodiments the extruded ribbon can be passed through a crimper 235 to shape the extruded ribbon into individual casing component pieces. A crimper can include two molds facing open to each other, each mounted on a roller. FIG. 11 shows an exemplary crimper mold 300 including two rows of cup-like molds 305 each having an edge 310 and a substantially concave interior 315. The molds 305 are designed to form extruded ribbon into lentil shaped casing components. As the extruded ribbon passes through the rollers, the crimper molds 305 press together with the extruded ribbon in the middle so as to mold the extruded ribbon in the shape of the crimper molds. Each of the crimper molds can have an edge 310 that presses to nearly touch the edge of the opposing crimper mold; the crimper molds might not cut the extruded ribbon into individual pieces, but the mold edges press the extruded ribbon to a sufficiently thin depth that the extruded ribbon can easily be broken into separate individual pieces, such as by hand or using a vibratory pan.

In other embodiments the extruded ribbon can be passed through a cutter, such as a chain die cutter to shape the extruded ribbon into individual pieces and to simultaneously cut the individual pieces apart. The chain die cutter can include two sets of molds that open facing each other through which the extruded ribbon is passed. The edges of each of the molds can be sharp to cut the individual pieces from the extruded ribbon as they are molded.

Referring again to FIG. 10, the individual pieces can be dried, for example in a dryer 240. In some embodiments the moisture in the casing component pieces can be reduced to less than about 5% or less than about 3% through drying. The casing component pieces can be coated with a binder 245 and a particulate coating 250, for example in a coating drum 255. The casing component pieces can be coated with the binder before being coated with a particulate coating, or the binder and particulate coating can be applied simultaneously to the casing component pieces. The coated extruded product can be dried, for example in a dryer 240. In some embodiments the extruded product can be coated with a binder 245 and dried simultaneously. The extruded product or coated extruded product can be cooled after any step. The extruded product or coated extruded product can be packaged 260.

In embodiments where the agglomerated particles include baked dough crumbs, the baked dough crumbs may be made by grinding a baked dough foodstuff to form particulates, such as using a mill. Suitable baked dough foodstuffs can be made using conventional cookie or cracker formulations, or flat bread formulations, and conventional dough forming equipment and machinery and baking ovens. For example, in embodiments of the invention, baked dough foodstuffs for forming baked dough crumbs may be produced using a rotary molder to form dough pieces and the dough pieces may be baked in an oven to obtain baked dough foodstuffs. In other embodiments of the invention, a baked dough foodstuff may be produced by forming a dough sheet, cutting the sheeted dough into pieces, and baking the pieces in an oven to obtain baked dough foodstuffs.

### EXAMPLES

The following examples, while illustrative of individual embodiments, are not intended to limit the scope of the described invention, and the reader should not interpret them in this way.

### Example 1

Coated extruded snack products of the invention have been prepared using the components and ingredients in the proportions described in Table 1.

TABLE 1

| | Weight percent | Ingredient | Example 1 | Example 2 | Example 3 | Example 4 |
|---|---|---|---|---|---|---|
| Casing Component | 30%-40% | Flour | 25%-35% | 20%-40% | 10%-50% | 9.2%-73.6% |
| | | Sugar | 3%-7% | 1%-10% | 1%-15% | 0.7%-24% |
| | | Cocoas | 2%-5% | 1%-7% | 1%-10% | 1.2%-24% |
| | | Other | 0%-1% | 0%-2% | 0%-3% | 0%-2.4% |
| Crème Filling | 40%-70% | Solid Fat | 5%-15% | 5%-15% | 0%-20% | 0.2%-11.3% |
| | | Liquid Oil | 3%-7% | 0%-10% | 0%-15% | 0.2%-11.3% |
| | | Sugar | 30%-50% | 20%-50% | 10%-60% | 2%-45% |
| | | Flavor | 0%-.1% | 0%-0.5% | 0%-1% | 0%-04% |
| | | Crumbs | 0%-5% | 0%-7% | 0%-10% | 0%-11.3% |
| | | Other | 0%-.5% | 0%-1% | 0%-2% | 0%-0.8% |
| Coating | 0%-4% | Carbohydrate | 0%-1% | 0%-2% | 0%-4% | 0%-1% |

1. A crispy co-extruded foodstuff comprising:
an extruded casing having a flour component that includes from about 37% to about 92% by weight wheat flour and from about 3% to about 30% by weight sugar;
an extruded filling disposed within the extruded casing wherein filling weight is from about 20 wt % to about 75 wt % of total weight of the co-extruded foodstuff; and
wherein the overall co-extruded foodstuff has a density of about 0.45 g/mL to about 0.85 g/mL.

2. The co-extruded foodstuff of claim 1, wherein the flour component consists essentially of wheat flour.

3. The co-extruded foodstuff according to claim 1, wherein the flour component includes up to about 20 wt % of a non-wheat flour that includes at least one of rice flour, corn flour, and potato flour.

4. The co-extruded foodstuff according to claim 1, having a density of about 0.6 g/mL to about 0.8 g/mL.

5. The co-extruded foodstuff according to claim 1, having an Aw of about 0.1 to about 0.6.

6. The co-extruded foodstuff according to any one of claims 1, having a moisture content of about 0.5 wt % to about 4 wt % of the weight of the co-extruded foodstuff

7. The co-extruded foodstuff according to claim 1, wherein the filling has a viscosity of from about 2500 cP to about 25000 cP.

8. The co-extruded foodstuff according to claim 1, wherein the casing comprises about 10 wt % to about 20 wt % of sugar.

9. The co-extruded foodstuff according claim 1, the foodstuff having a length dimension that is greater than a width dimension and the foodstuff having compressive strength along the width dimension of from about 150 g to about 1200 g.

10. The co-extruded foodstuff according claim 1, the foodstuff having a length dimension that is greater than a width dimension and the foodstuff having compressive strength along the length dimension of from about 220 g to about 1300 g.

11. The co-extruded foodstuff according to claim 1, wherein the extruded casing comprises about 5% to about 15% by weight cocoa.

12. The co-extruded foodstuff according to claim 1, wherein the extruded casing further comprises from about 3% to about 30% by weight cocoa.

13. The co-extruded foodstuff according to claim 1, wherein the extruded casing further comprises from about 9% to about 18% by weight cocoa.

14. The co-extruded foodstuff according to claim 1, wherein the extruded casing further comprises from about 10% to about 15% by weight cocoa.

15. A method of co-extruding a baked foodstuff comprising:
mixing a casing material comprising from about 10% to about 100% by weight wheat flour and from about 3% to about 30% by weight sugar;
mixing a filling material comprising a solid fat, a liquid fat, and sugar; and
co-extruding the casing material and filling material at filling to casing ratio of about 1:4 to about 3:1 to produce an extruded rope.
